(19) United States
(12) Patent Application Publication
(10) Pub. No.: US 2021/0405327 A1
(43) Pub. Date: Dec. 30, 2021

(54) Optical Imaging System

(71) Applicant: ZHEJIANG SUNNY OPTICS CO., LTD., Ningbo (CN)

(72) Inventors: Fujian DAI, Ningbo (CN); Chen CHEN, Ningbo (CN); Wuchao XU, Ningbo (CN); Liefeng ZHAO, Ningbo (CN)

(21) Appl. No.: 17/349,887

(22) Filed: Jun. 16, 2021

(30) Foreign Application Priority Data
Jun. 28, 2020 (CN) 202010598658.2

(51) Int. Cl. G02B 13/00; G02B 9/64

(52) U.S. Cl. CPC G02B 13/0045; G02B 9/64

(57) ABSTRACT

The disclosure provides an optical imaging system, which sequentially includes, from an object side to an image side along an optical axis: a first lens, second lens, third lens, fourth lens, fifth lens, sixth lens and seventh lens with refractive power; and a diaphragm arranged between the second lens and the third lens, wherein an effective focal length f1 of the first lens and a total effective focal length f of the optical imaging system meet 1.5<f1/f<3.0; and a radius of curvature R13 of an object-side surface of the seventh lens and a radius of curvature R14 of an image-side surface of the seventh lens meet 1.5<R13/R14<2.0.

### CROSS-REFERENCE TO RELATED APPLICATION(S)

The present disclosure claims priority to Chinese Patent Application No. 202010598658.2, filed on Jun. 28, 2020 and entitled “Optical Imaging System”, the contents of which are hereby incorporated by reference in its entirety.

### TECHNICAL FIELD

The disclosure relates to the field of optical elements, and particularly to an optical imaging system.

### BACKGROUND

With a rapid development of electronic products, optical imaging systems have been applied more and more extensively. On one hand, due to a trend of development of electronic products to miniaturization, an optical imaging system is required to be high in image quality and relatively small, to effectively reduce the product cost and conform to a personalized design better. On the other hand, users also make higher requirements on the imaging quality of sceneries shot by optical imaging systems, which are applied to electronic products. In addition, with the improvement of the performance of photosensitive elements Charge Coupled Devices (CCDs) and Complementary Metal Oxide Semiconductors (CMOSs) and the size reduction of pixel elements, optical imaging systems carried in electronic products, such as smart phones, have gradually developed to the fields of miniaturization, large aperture, high resolution, etc.

### SUMMARY

An aspect of the disclosure provides an optical imaging system, which sequentially includes, from an object side to an image side along an optical axis: a first lens, second lens, third lens, fourth lens, fifth lens, sixth lens and seventh lens with refractive powers; and a diaphragm arranged between the second lens and the third lens, wherein an effective focal length f1 of the first lens and a total effective focal length f of the optical imaging system meet 1.5<f1/f<3.0; and a radius of curvature R13 of an object-side surface of the seventh lens and a radius of curvature R14 of an image-side surface of the seventh lens meet 1.5<R13/R14<2.0.

In an implementation mode, an object-side surface of the first lens to the image-side surface of the seventh lens include at least one aspherical mirror surface.

In an implementation mode, Fno, an F-number of the optical imaging system, meets Fno<2.0.

In an implementation mode, an effective focal length f3 of the third lens and an effective focal length f4 of the fourth lens meet −1.5<f3/f4<−0.5.

In an implementation mode, an effective focal length f7 of the seventh lens and the total effective focal length f of the optical imaging system meet −2.0<f7/f<−1.0.

In an implementation mode, a radius of curvature R3 of an object-side surface of the second lens and a radius of curvature R1 of an object-side surface of the first lens meet 1.0<R3/R1<2.0.

In an implementation mode, a radius of curvature R2 of an image-side surface of the first lens and a radius of curvature R4 of an image-side surface of the second lens meet 1.5<R2/R4<4.5.

In an implementation mode, a radius of curvature R5 of an object-side surface of the third lens and a radius of curvature R6 of an image-side surface of the third lens meet −6.0<R5/R6<−1.0.

In an implementation mode, a center thickness CT3 of the third lens on the optical axis and a center thickness CT2 of the second lens on the optical axis meet 1.5<CT3/CT2<2.5.

In an implementation mode, a center thickness CT1 of the first lens on the optical axis and a spacing distance T23 of the second lens and the third lens on the optical axis meet 1.5<CT1/T23<2.5.

In an implementation mode, a center thickness CT5 of the fifth lens on the optical axis and a center thickness CT4 of the fourth lens on the optical axis meet 1.5<CT5/CT4<2.5.

In an implementation mode, Semi-Field Of View (Semi-FOV), a half of a maximum field of view of the optical imaging system, meets Semi-FOV≥45°.

In an implementation mode, a spacing distance T67 of the sixth lens and the seventh lens on the optical axis and a center thickness CT6 of the sixth lens on the optical axis meet T67/CT6>1.0.

In an implementation mode, TTL, a distance from an object-side surface of the first lens to an imaging surface of the optical imaging system on the optical axis and ImgH, a half of a diagonal length of an effective pixel region on the imaging surface of the optical imaging system meet TTL/ImgH<1.5.

Another aspect of the disclosure provides an optical imaging system, which sequentially includes, from an object side to an image side along an optical axis: a first lens, second lens, third lens, fourth lens, fifth lens, sixth lens and seventh lens with refractive powers; and a diaphragm arranged between the second lens and the third lens, wherein an effective focal length f1 of the first lens and a total effective focal length f of the optical imaging system meet 1.5<f1/f<3.0; and a center thickness CT1 of the first lens on the optical axis and a spacing distance T23 of the second lens and the third lens on the optical axis meet 1.5<CT1/T23<2.5.

According to some embodiments of the disclosure, the refractive power is configured reasonably, and optical parameters are optimized, so that the provided optical imaging system is applicable to a portable electronic product, and has at least one of beneficial effects of large aperture, large image surface, small size, high imaging quality, etc.

### BRIEF DESCRIPTION OF THE DRAWINGS

Detailed descriptions made to unrestrictive implementation modes with reference to the following drawings are read to make the other characteristics, purposes and advantages of the disclosure more apparent.

FIG. 1 illustrates a structure diagram of an optical imaging system according to embodiment 1 of the disclosure;

FIG. 2A to FIG. 2D show a longitudinal aberration curve, astigmatism curve, distortion curve and lateral color curve of an optical imaging system according to embodiment 1 respectively;

FIG. 3 illustrates a structure diagram of an optical imaging system according to embodiment 2 of the disclosure;

FIG. 4A to FIG. 4D show a longitudinal aberration curve, astigmatism curve, distortion curve and lateral color curve of an optical imaging system according to embodiment 2 respectively;

FIG. 5 illustrates a structure diagram of an optical imaging system according to embodiment 3 of the disclosure;

FIG. 6A to FIG. 6D show a longitudinal aberration curve, astigmatism curve, distortion curve and lateral color curve of an optical imaging system according to embodiment 3 respectively;

FIG. 7 illustrates a structure diagram of an optical imaging system according to embodiment 4 of the disclosure;

FIG. 8A to FIG. 8D show a longitudinal aberration curve, astigmatism curve, distortion curve and lateral color curve of an optical imaging system according to embodiment 4 respectively;

FIG. 9 illustrates a structure diagram of an optical imaging system according to embodiment 5 of the disclosure;

FIG. 10A to FIG. 10D show a longitudinal aberration curve, astigmatism curve, distortion curve and lateral color curve of an optical imaging system according to embodiment 5 respectively;

FIG. 11 illustrates a structure diagram of an optical imaging system according to embodiment 6 of the disclosure.

FIG. 12A to FIG. 12D show a longitudinal aberration curve, astigmatism curve, distortion curve and lateral color curve of an optical imaging system according to embodiment 6 respectively;

FIG. 13 illustrates a structure diagram of an optical imaging system according to embodiment 7 of the disclosure;

FIG. 14A to FIG. 14D show a longitudinal aberration curve, astigmatism curve, distortion curve and lateral color curve of an optical imaging system according to embodiment 7 respectively;

FIG. 15 illustrates a structure diagram of an optical imaging system according to embodiment 8 of the disclosure;

FIG. 16A to FIG. 16D show a longitudinal aberration curve, astigmatism curve, distortion curve and lateral color curve of an optical imaging system according to embodiment 8 respectively;

FIG. 17 illustrates a structure diagram of an optical imaging system according to embodiment 9 of the disclosure; and

FIG. 18A to FIG. 18D show a longitudinal aberration curve, astigmatism curve, distortion curve and lateral color curve of an optical imaging system according to embodiment 9 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, etc. are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspherical shape shown in the drawings is shown by some embodiments. That is, the spherical shape or the aspherical shape is not limited to the spherical shape or aspherical shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain” and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings usually understood by those of ordinary skill in the art of the disclosure. It should also be understood that the terms (for example, terms defined in a common dictionary) should be explained to have meanings consistent with the meanings in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging system according to an exemplary implementation mode of the disclosure includes seven lenses with refractive power, i.e., a first lens, a second lens, a third lens, a fourth lens, a fifth lens, a sixth lens, and a seventh lens respectively. The seven lenses are sequentially arranged from an object side to an image side along an optical axis. In the first lens to the seventh lens, there may be a spacing distance between any two adjacent lenses.

In the exemplary implementation mode, the optical imaging system according to the disclosure meets 1.5<f1/f<3.0, wherein f1 is an effective focal length of the first lens, and f is a total effective focal length of the optical imaging system. More specifically, f1 and f further meets 1.8<f1/f<2.8. 1.5<f1/f/3.0 is met, so that the refractive power of the first lens is configured reasonably, an off-axis aberration of the system is balanced, and an aberration correction capability of the system is improved.

In the exemplary implementation mode, the optical imaging system meets Fno<2.0, wherein Fno is an F-number of the optical imaging system. Fno<2.0 is met, so that the characteristic of large aperture of the system is achieved.

In the exemplary implementation mode, the optical imaging system meets −1.5<f3/f4<−0.5, wherein f3 is an effective focal length of the third lens, and f4 is an effective focal length of the fourth lens. More specifically, f3 and f4 further meet −1.2<f3/f4<−0.6. −1.5<f3/f4<−0.5 is met, so that the refractive power of the system is configured reasonably, and positive and negative spherical aberrations of a previous lens and a next lens may offset each other.

In the exemplary implementation mode, the optical imaging system meets −2.0<f7/f<−1.0, wherein f7 is an effective focal length of the seventh lens, and f is the total effective focal length of the optical imaging system. More specifically, f7 and f further meet −1.6<f7/f<−1.2. −2.0<f7/f<−1.0 is met, so that an aberration contribution of the seventh lens is configured reasonably to reduce a sensitivity of the last lens of the system and improve the manufacturability of the system.

In the exemplary implementation mode, the optical imaging system meets 1.0<R3/R1<2.0, wherein R3 is a radius of curvature of an object-side surface of the second lens, and R1 is a radius of curvature of an object-side surface of the first lens. Meeting 1.0<R3/R1<2.0 is favorable for the system to implement deflection of a light path relatively well and balance a high-order spherical aberration generated by the imaging system.

In the exemplary implementation mode, the optical imaging system meets 1.5<R2/R4<4.5, wherein R2 is a radius of curvature of an image-side surface of the first lens, and R4 is a radius of curvature of an image-side surface of the second lens. More specifically, R2 and R4 further meet 1.7<R2/R4<4.1. 1.5<R2/R4<4.5 is met, so that aberrations generated in the first two lenses of the optical imaging system is controlled effectively.

In the exemplary implementation mode, the optical imaging system meets −6.0<R5/R6<−1.0, wherein R5 is a radius of curvature of an object-side surface of the third lens, and R6 is a radius of curvature of an image-side surface of the third lens. −6.0<R5/R6/−1.0 is met, so that the sensitivity of the third lens is reduced effectively, and resolving power of the lens is improved.

In the exemplary implementation mode, the optical imaging system meets 1.5<R13/R14<2.0, wherein R13 is a radius of curvature of an object-side surface of the seventh lens, and R14 is a radius of curvature of an image-side surface of the seventh lens. More specifically, R13 and R14 further meet 1.6<R13/R14<1.8. Meeting 1.5<R13/R14<2.0 is favorable for ensuring the machining and forming of the lens, and is also favorable for controlling a marginal ray deflection angle of the system reasonably and reducing the sensitivity of the system effectively.

In the exemplary implementation mode, the optical imaging system meets 1.5<CT3/CT2<2.5, wherein CT3 is a center thickness of the third lens on the optical axis, and CT2 is a center thickness of the second lens on the optical axis. More specifically, CT3 and CT2 further meet 1.7<CT3/CT2<2.1. Meeting 1.5<CT3/CT2<2.5 is favorable for controlling a distortion contribution in each FOV of the system in a reasonable range, particularly controlling a system distortion in a range of 0 to 2.5%, to improve the imaging quality.

In the exemplary implementation mode, the optical imaging system meets 1.5<CT1/T23<2.5, wherein CT1 is a center thickness of the first lens on the optical axis, and T23 is a spacing distance of the second lens and the third lens on the optical axis. More specifically, CT1 and T23 further meet 1.8<CT1/T23<2.4. 1.5<CT1/T23<2.5 is met, so that a field curvature contribution in each FOV of the system is controlled in a reasonable range to balance field curvature contributions generated by the other lenses.

In the exemplary implementation mode, the optical imaging system meets 1.5<CT5/CT4<2.5, wherein CT5 is a center thickness of the fifth lens on the optical axis, and CT4 is a center thickness of the fourth lens on the optical axis. More specifically, CT5 and CT4 further meet 1.7<CT5/CT4<2.5. 1.5<CT5/CT4<2.5 is met, so that a distortion of the system is regulated reasonably to be finally controlled in a certain range to achieve high imaging quality in an off-axis FOV of the system.

In the exemplary implementation mode, the optical imaging system meets Semi-FOV≥45°, wherein Semi-FOV is a half of a maximum Semi-FOV of the optical imaging system. More specifically, Semi-FOV further meets Semi-FOV≥46°. Meeting Semi-FOV≥45° is favorable for achieving the characteristic of wide angle of the system.

In the exemplary implementation mode, the optical imaging system meets T67/CT6>1.0, wherein T67 is a spacing distance of the sixth lens and the seventh lens on the optical axis, and CT6 is a center thickness of the sixth lens on the optical axis. More specifically, T67 and CT6 may further meet T67/CT6>1.1. Meeting T67/CT6>1.0 is favorable for controlling the reasonability of the shape of the sixth lens, balancing a field curvature of the system, and improving the aberration correction capability of the system.

In the exemplary implementation mode, the optical imaging system meets TTL/ImgH<1.5, wherein TTL is a distance from an object-side surface of the first lens to an imaging surface of the optical imaging system on the optical axis, and ImgH is a half of a diagonal length of an effective pixel region on the imaging surface of the optical imaging system. TTL/ImgH<1.5 is met, so that the characteristic of ultra-thin design of the system may be achieved.

In the exemplary implementation mode, the optical imaging system further includes a diaphragm arranged between the second lens and the third lens. In some embodiments, the optical imaging system further includes an optical filter configured to correct a chromatic aberration and/or a protective glass configured to protect a photosensitive element on the imaging surface. The disclosure provides an optical imaging system with the characteristics of small size, large image surface, large aperture, high resolution, high imaging quality, etc. The optical imaging system according to the implementation mode of the disclosure adopts multiple lenses, for example, the abovementioned seven. The refractive power and surface types of each lens, the center thickness of each lens, on-axis distances between the lenses and the like are reasonably configured to effectively converge incident light, reduce a Total Track Length (TTL) of the imaging lens assembly, improve the machinability of the imaging lens assembly, and ensure that the optical imaging system is more favorable for production and machining.

In the implementation mode of the disclosure, at least one of mirror surfaces of each lens is an aspherical mirror surface, namely at least one mirror surface in the object-side surface of the first lens to an image-side surface of the seventh lens is an aspherical mirror surface. An aspherical lens has a characteristic that a curvature keeps changing continuously from a center of the lens to a periphery of the lens. Unlike a spherical lens with a constant curvature from a center of the lens to a periphery of the lens, the aspherical lens has a better radius of curvature characteristic and the advantages of improving distortions and improving astigmatic aberrations. With adoption of the aspherical lens, astigmatic aberrations during imaging are eliminated as much as possible, thereby improving the imaging quality. Optionally, at least one of the object-side surface and image-side surface of each lens in the first lens, the second lens, the third lens, the fourth lens, the fifth lens, the sixth lens and the seventh lens is an aspherical mirror surface. Optionally, both the object-side surface and image-side surface of each lens in the first lens, the second lens, the third lens, the fourth lens, the fifth lens, the sixth lens and the seventh lens are aspherical mirror surfaces.

However, those skilled in the art should know that the number of the lenses forming the optical imaging system may be changed without departing from the technical solutions claimed in the disclosure to achieve each result and advantage described in the specification. For example, although descriptions are made in the implementation mode with seven lenses as an example, the optical imaging system is not limited to include seven lenses. If necessary, the optical imaging system may also include another number of lenses.

Specific embodiments applied to the optical imaging system of the abovementioned implementation mode will further be described below with reference to the drawings.

### Embodiment 1

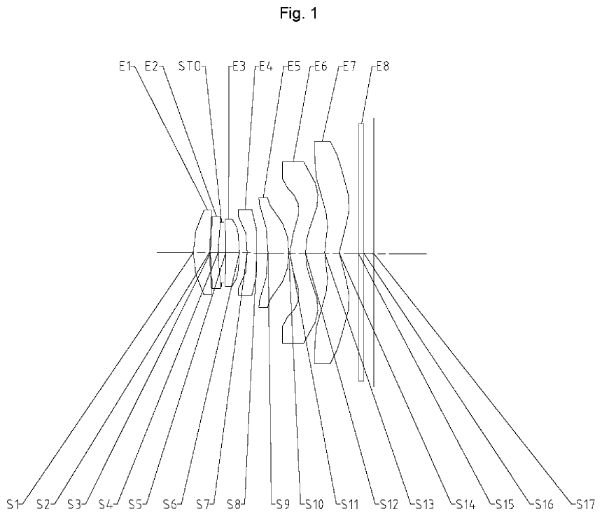

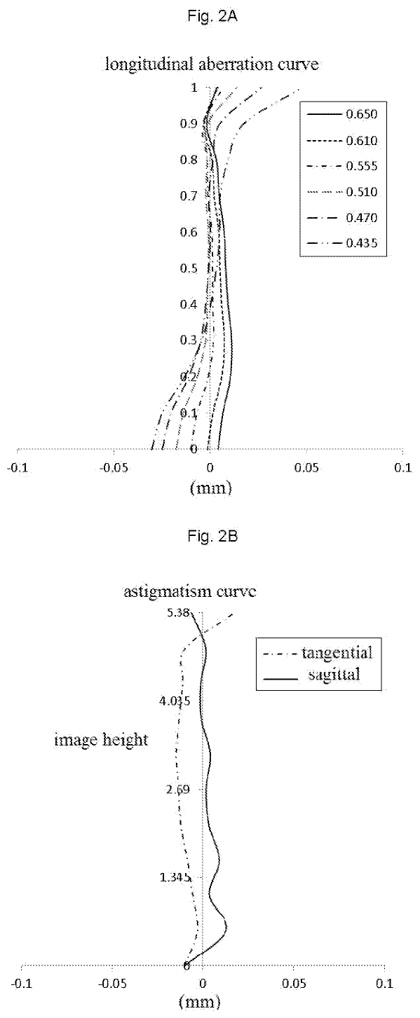

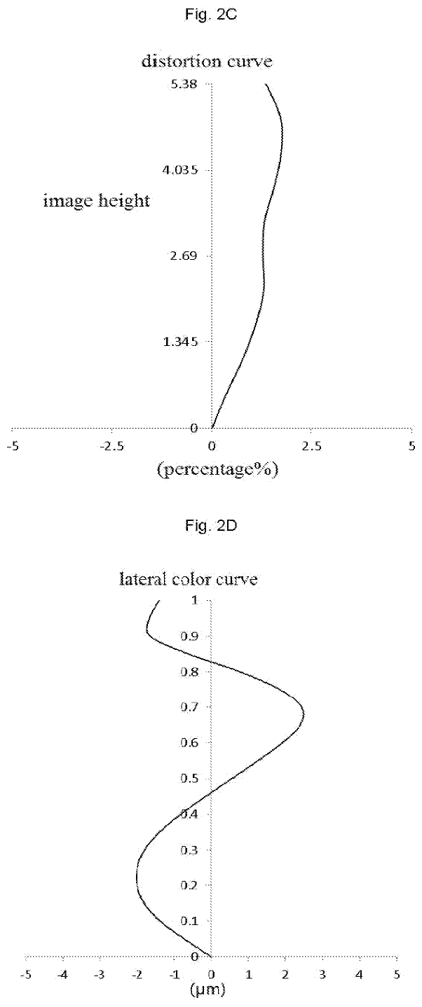

An optical imaging system according to embodiment 1 of the disclosure will be described below with reference to FIG. 1 to FIG. 2D. FIG. 1 is a structure diagram of an optical imaging system according to embodiment 1 of the disclosure.

As shown in FIG. 1, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a concave surface. The fifth lens E5 has a negative refractive power, an object-side surface S9 thereof is a concave surface, while an image-side surface S10 is a convex surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16, and is finally imaged on the imaging surface S17.

Table 1 is a basic parameter table of the optical imaging system of embodiment 1, and units of the radius of curvature, the thickness/distance and the focal length are all millimeter (mm).

TABLE 1

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 4.0074 | 0.6480 | 1.55 | 56.1 | 9.65 | 0.0000 |
| S2 | Aspherical | 15.8145 | 0.0400 | | | | 0.0000 |
| S3 | Aspherical | 4.6401 | 0.3000 | 1.68 | 19.2 | −43.02 | 0.0000 |
| S4 | Aspherical | 3.8979 | 0.1405 | | | | 0.0000 |
| STO | Spherical | Infinite | 0.1738 | | | | |
| S5 | Aspherical | 15.6080 | 0.5335 | 1.55 | 56.1 | 10.55 | 0.0000 |
| S6 | Aspherical | −9.0212 | 0.3156 | | | | 0.0000 |
| S7 | Aspherical | −12.7877 | 0.3900 | 1.68 | 19.2 | −14.77 | 0.0000 |
| S8 | Aspherical | 46.4108 | 0.4437 | | | | 0.0000 |
| S9 | Aspherical | −6.0454 | 0.8269 | 1.55 | 56.1 | −47.39 | 0.0000 |
| S10 | Aspherical | −8.2699 | 0.0400 | | | | −0.3648 |
| S11 | Aspherical | 1.7993 | 0.6342 | 1.55 | 56.1 | 5.58 | −1.0000 |
| S12 | Aspherical | 3.8475 | 0.7605 | | | | 0.0000 |
| S13 | Aspherical | 2.2923 | 0.5779 | 1.54 | 55.7 | −7.40 | −1.0000 |
| S14 | Aspherical | 1.3250 | 0.7711 | | | | −3.6067 |
| S15 | Spherical | Infinite | 0.2100 | 1.62 | 64.2 | | |
| S16 | Spherical | Infinite | 0.3943 | | | | |
| S17 | Spherical | Infinite | | | | | |

In the example, a total effective focal length f of the optical imaging system is 4.94 mm, a TTL (i.e., a distance from the object-side surface S1 of the first lens E1 to the imaging surface S17 of the optical imaging system on an optical axis) of the optical imaging system is 7.20 mm, ImgH, a half of a diagonal length of an effective pixel region on the imaging surface S17 of the optical imaging system, is 5.38 mm; Semi-FOV, a half of a maximum Field of View of the optical imaging system, is 47.0°, and Fno, an F-number of the optical imaging system, is 1.90.

In embodiment 1, both the object-side surface and image-side surface of any lens in the first lens E1 to the seventh lens E7 are aspherical surfaces, and a surface type x of each aspherical lens is defined through, but not limited to, the following aspherical surface formula:

$$x = \frac{c {h}^{2}}{1 + \sqrt{1 - ( k + 1 ) {c}^{2} {h}^{2}}} + \sum {Aih}^{i} , \qquad ( 1 )$$

wherein x is a distance vector height from a vertex of the aspherical surface when the aspherical surface is at a height of h along the optical axis direction; c is a paraxial curvature of the aspherical surface, c=1/R (namely, the paraxial curvature c is a reciprocal of the radius of curvature R in Table 1); k is a conic coefficient; and Ai is a correction coefficient of the i-th order of the aspherical surface. The following Tables 2-1 and 2-2 show high-order coefficients A₄, A₆, A₈, A₁₀, A₁₂, A₁₄, A₁₆, A₁₈, A₂₀, A₂₂, A₂₄, A₂₆, A₂₈ and A₃₀ applied to the aspherical mirror surfaces S1-S14 in embodiment 1.

TABLE 2-1

| Surface | | | | | | | |
|---|---|---|---|---|---|---|---|
| number | A4 | A6 | A8 | A10 | A12 | A14 | A16 |
| S1 | 4.2394E−03 | 4.4554E−03 | −1.0838E−02 | 1.9132E−02 | −1.9467E−02 | 1.2092E−02 | −4.5100E−03 |
| S2 | −5.7662E−02 | 1.5865E−01 | −2.4232E−01 | 2.5390E−01 | −1.8029E−01 | 8.3923E−02 | −2.4713E−02 |
| S3 | −1.0962E−01 | 1.5727E−01 | −2.3820E−01 | 2.6433E−01 | −2.0496E−01 | 1.0532E−01 | −3.3158E−02 |
| S4 | −7.2913E−02 | 1.3248E−02 | 4.9093E−02 | −1.8338E−01 | 3.2953E−01 | −3.4686E−01 | 2.1881E−01 |
| S5 | −2.0031E−02 | −3.2253E−02 | 1.2505E−01 | −3.7212E−01 | 6.6340E−01 | −7.2208E−01 | 4.7196E−01 |
| S6 | −3.3714E−02 | −1.9874E−02 | 3.6727E−02 | −7.7033E−02 | 1.0081E−01 | −8.2518E−02 | 4.1395E−02 |
| S7 | −7.0909E−02 | −3.4382E−04 | −1.8398E−02 | 4.7100E−02 | −6.5453E−02 | 5.9320E−02 | −3.2080E−02 |
| S8 | −4.1747E−02 | −1.4379E−04 | 8.5613E−04 | 1.2614E−03 | −1.5689E−03 | 1.5780E−03 | −8.7236E−04 |
| S9 | 2.0823E−02 | −2.9516E−02 | 3.6157E−02 | −3.8738E−02 | 2.9117E−02 | −1.5757E−02 | 6.4784E−03 |
| S10 | −1.6691E−01 | 7.8585E−02 | 5.9916E−02 | −1.9758E−01 | 2.5708E−01 | −2.1528E−01 | 1.2581E−01 |
| S11 | −9.5453E−02 | 6.3150E−02 | −5.6534E−02 | 3.8020E−02 | −1.9561E−02 | 7.8344E−03 | −2.4416E−03 |
| S12 | 1.1188E−01 | −1.1623E−01 | 6.5831E−02 | −2.7793E−02 | 8.9937E−03 | −2.2255E−03 | 4.1821E−04 |
| S13 | −1.4659E−01 | 3.7508E−02 | 1.3290E−03 | −5.9926E−03 | 2.8179E−03 | −7.5651E−04 | 1.3517E−04 |
| S14 | −1.9487E−01 | 8.4557E−02 | −3.0724E−02 | 8.7320E−03 | −1.9215E−03 | 3.2580E−04 | −4.2274E−05 |

TABLE 2-2

| Surface | | | | | | | |
|---|---|---|---|---|---|---|---|
| number | A18 | A20 | A22 | A24 | A26 | A28 | A30 |
| S1 | 9.2446E−04 | −8.0272E−05 | 0.0000E+00 | 0.0000E+00 | 0.0000E+00 | 0.0000E+00 | 0.0000E+00 |
| S2 | 4.2884E−03 | −3.4716E−04 | 0.0000E+00 | 0.0000E+00 | 0.0000E+00 | 0.0000E+00 | 0.0000E+00 |
| S3 | 5.6801E−03 | −3.9495E−04 | 0.0000E+00 | 0.0000E+00 | 0.0000E+00 | 0.0000E+00 | 0.0000E+00 |
| S4 | −7.6199E−02 | 1.1257E−02 | 0.0000E+00 | 0.0000E+00 | 0.0000E+00 | 0.0000E+00 | 0.0000E+00 |
| S5 | −1.7004E−01 | 2.5872E−02 | 0.0000E+00 | 0.0000E+00 | 0.0000E+00 | 0.0000E+00 | 0.0000E+00 |
| S6 | −1.1759E−02 | 1.4332E−03 | 0.0000E+00 | 0.0000E+00 | 0.0000E+00 | 0.0000E+00 | 0.0000E+00 |
| S7 | 9.2952E−03 | −1.0997E−03 | 0.0000E+00 | 0.0000E+00 | 0.0000E+00 | 0.0000E+00 | 0.0000E+00 |
| S8 | 2.2983E−04 | −2.2647E−05 | 0.0000E+00 | 0.0000E+00 | 0.0000E+00 | 0.0000E+00 | 0.0000E+00 |
| S9 | −2.0824E−03 | 5.1984E−04 | −9.4350E−05 | 1.0772E−05 | −5.6539E−07 | 0.0000E+00 | 0.0000E+00 |
| S10 | −5.2543E−02 | 1.5748E−02 | −3.3547E−03 | 4.9512E−04 | −4.8108E−05 | 2.7685E−06 | −7.1534E−08 |
| S11 | 5.8489E−04 | −1.0553E−04 | 1.3947E−05 | −1.2978E−06 | 7.9995E−08 | −2.9187E−09 | 4.7577E−11 |
| S12 | −5.9147E−05 | 6.2143E−06 | −4.7517E−07 | 2.5576E−08 | −9.1528E−10 | 1.9498E−11 | −1.8672E−13 |
| S13 | −1.6902E−05 | 1.5049E−06 | −9.5200E−08 | 4.1875E−09 | −1.2188E−10 | 2.1122E−12 | −1.6510E−14 |
| S14 | 4.1604E−06 | −3.0647E−07 | 1.6550E−08 | −6.3343E−10 | 1 6219E−11 | −2.4859E−13 | 1.7212E−15 |

FIG. 2A shows a longitudinal aberration curve of the optical imaging system according to embodiment 1 to represent deviation of a convergence focal point after light with different wavelengths passes through the lens. FIG. 2B shows an astigmatism curve of the optical imaging system according to embodiment 1 to represent a tangential image surface curvature and a sagittal image surface curvature. FIG. 2C shows a distortion curve of the optical imaging system according to embodiment 1 to represent distortion values corresponding to different image heights. FIG. 2D shows a lateral color curve of the optical imaging system according to embodiment 1 to represent deviation of different image heights on the imaging surface after the light passes through the lens. According to FIG. 2A to FIG. 2D, it can be seen that the optical imaging system provided in embodiment 1 achieves high imaging quality.

### Embodiment 2

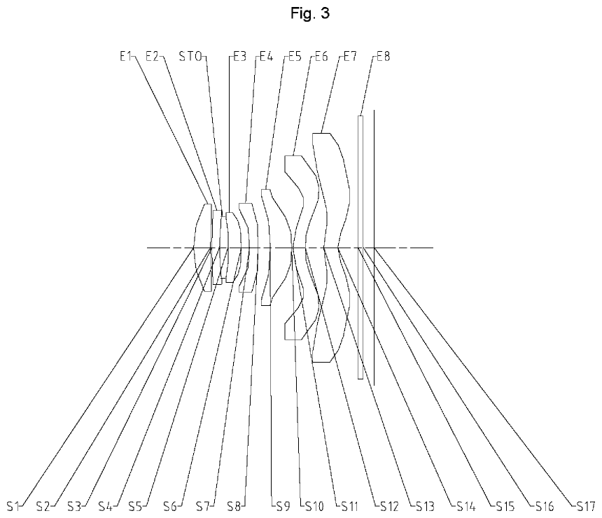

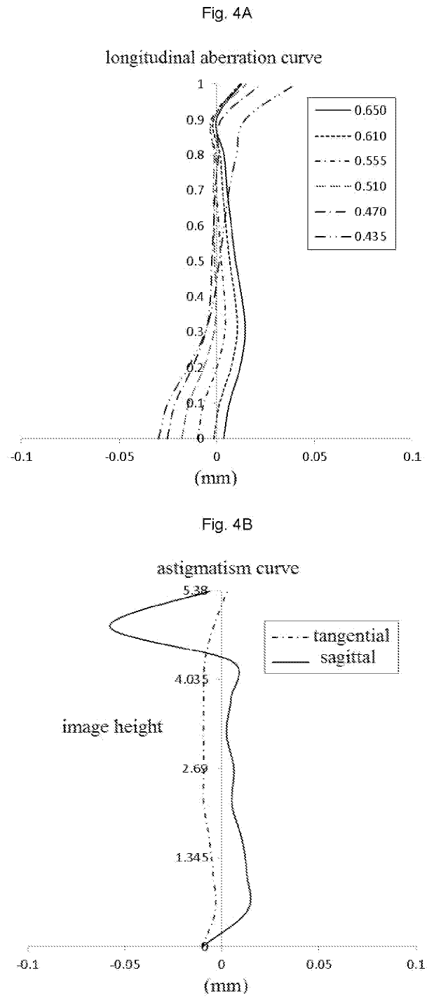

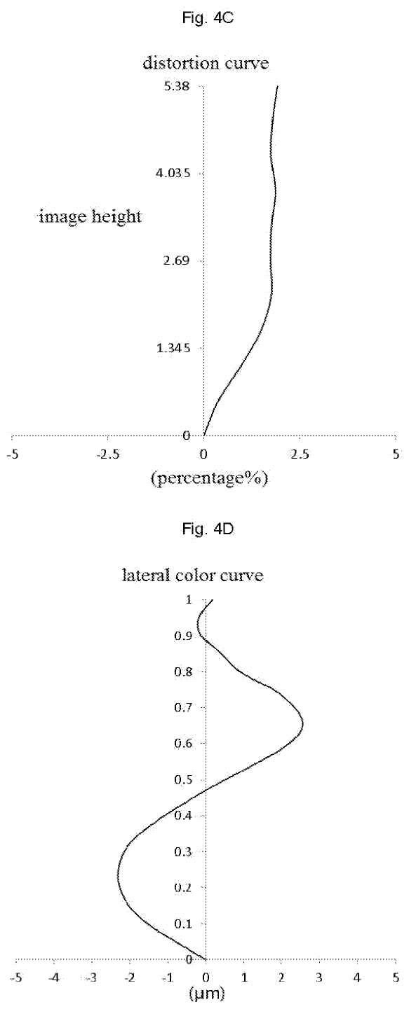

An optical imaging system according to embodiment 2 of the disclosure will be described below with reference to FIG. 3 to FIG. 4D. In the embodiment and the following embodiments, part of descriptions similar to those about embodiment 1 is omitted for simplicity. FIG. 3 is a structure diagram of an optical imaging system according to embodiment 2 of the disclosure.

As shown in FIG. 3, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a positive refractive power, an object-side surface S9 thereof is a concave surface, while an image-side surface S10 is a convex surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.92 mm, a TTL of the optical imaging system is 7.20 mm, ImgH, a half of a diagonal length of an effective pixel region on the imaging surface S17 of the optical imaging system, is 5.38 mm, Semi-FOV, a half of a maximum field of view of the optical imaging system, is 47.0°, and Fno, an F-number of the optical imaging system, is 1.90.

Table 3 is a basic parameter table of the optical imaging system of embodiment 2, and units of the radius of curvature, the thickness/distance and the focal length are all mm. Tables 4-1 and 4-2 show high-order coefficients applied to each aspherical mirror surface in embodiment 2. A surface type of each aspherical surface is defined by formula (1) given in embodiment 1.

TABLE 3

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 3.9043 | 0.6710 | 1.55 | 56.1 | 9.03 | 0.0000 |
| S2 | Aspherical | 17.6534 | 0.0611 | | | | 0.0000 |
| S3 | Aspherical | 6.0893 | 0.3000 | 1.68 | 19.2 | −42.12 | 0.0000 |
| S4 | Aspherical | 4.9179 | 0.1157 | | | | 0.0000 |
| STO | Spherical | Infinite | 0.2213 | | | | |
| S5 | Aspherical | 41.9439 | 0.5376 | 1.55 | 56.1 | 11.35 | 0.0000 |
| S6 | Aspherical | −7.2338 | 0.3191 | | | | 0.0000 |
| S7 | Aspherical | −9.7023 | 0.3500 | 1.68 | 19.2 | −15.72 | 0.0000 |
| S8 | Aspherical | −111.3129 | 0.4831 | | | | 0.0000 |
| S9 | Aspherical | −8.4440 | 0.8561 | 1.55 | 56.1 | 270.27 | 0.0000 |
| S10 | Aspherical | −8.2726 | 0.0400 | | | | 0.0420 |
| S11 | Aspherical | 2.1174 | 0.5000 | 1.55 | 56.1 | 6.22 | −1.0000 |
| S12 | Aspherical | 5.1548 | 0.7374 | | | | 0.0000 |
| S13 | Aspherical | 2.0144 | 0.5611 | 1.54 | 55.7 | −7.07 | −1.0000 |
| S14 | Aspherical | 1.1880 | 0.8067 | | | | −1.0000 |
| S15 | Spherical | Infinite | 0.2100 | 1.62 | 64.2 | | |
| S16 | Spherical | Infinite | 0.4300 | | | | |
| S17 | Spherical | Infinite | | | | | |

TABLE 4-1

| Surface | | | | | | | |
|---|---|---|---|---|---|---|---|
| number | A4 | A6 | A8 | A10 | A12 | A14 | A16 |
| S1 | 7.1103E−04 | 6.6256E−03 | −1.4084E−02 | 2.1074E−02 | −1.9444E−02 | 1.1274E−02 | −3.9894E−03 |
| S2 | −3.7615E−02 | 6.2736E−02 | −6.2392E−02 | 3.7803E−02 | −7.5211E−03 | −6.9783E−03 | 5.8238E−03 |
| S3 | −7.9111E−02 | 6.6818E−02 | −6.7733E−02 | 5.5175E−02 | −3.2377E−02 | 1.2404E−02 | −2.2388E−03 |
| S4 | −5.8357E−02 | 6.2590E−03 | 3.5336E−02 | −1.1127E−01 | 1.8915E−01 | −1.9381E−01 | 1.2127E−01 |
| S5 | −2.3844E−02 | −3.0856E−02 | 9.1695E−02 | −2.6464E−01 | 4.6535E−01 | −5.0229E−01 | 3.2625E−01 |
| S6 | −3.1740E−02 | −2.7367E−02 | 2.4020E−02 | −3.0496E−02 | 2.7527E−02 | −1.4180E−02 | 3.6585E−03 |
| S7 | −5.2339E−02 | −1.2531E−02 | −2.8420E−02 | 7.1155E−02 | −8.9511E−02 | 7.5105E−02 | −3.8078E−02 |
| S8 | −2.9990E−02 | −6.0543E−03 | −1.7691E−03 | 2.5507E−03 | 9.1574E−04 | −8.4532E−04 | 7.8897E−05 |
| S9 | −1.2455E−02 | 2.5370E−02 | −2.6943E−02 | 8.7579E−03 | 8.4305E−03 | −1.3329E−02 | 8.9120E−03 |
| S10 | −1.4847E−01 | 5.7537E−02 | 7.2279E−02 | −1.9366E−01 | 2.3947E−01 | −1.9440E−01 | 1.1087E−01 |
| S11 | −1.0673E−02 | −7.3561E−03 | 4.5833E−03 | −1.3871E−02 | 1.4844E−02 | −8.6375E−03 | 3.2146E−03 |
| S12 | 1.6051E−01 | −1.1081E−01 | 3.1772E−02 | −3.0831E−04 | −3.4946E−03 | 1.5295E−03 | −3.7114E−04 |
| S13 | −1.4983E−01 | 2.6981E−02 | 1.3675E−02 | −1.4377E−02 | 6.5511E−03 | −1.8657E−03 | 3.6020E−04 |
| S14 | −2.1303E−01 | 9.2198E−02 | −3.3613E−02 | 9.6430E−03 | −2.1456E−03 | 3.6810E−04 | −4.8364E−05 |

TABLE 4-2

| Surface | | | | | | | |
|---|---|---|---|---|---|---|---|
| number | A18 | A20 | A22 | A24 | A26 | A28 | A30 |
| S1 | 7.8565E−04 | −6.6169E−05 | 0.0000E+00 | 0.0000E+00 | 0.0000E+00 | 0.0000E+00 | 0.0000E+00 |
| S2 | −1.7358E−03 | 1.8920E−04 | 0.0000E+00 | 0.0000E+00 | 0.0000E+00 | 0.0000E+00 | 0.0000E+00 |
| S3 | −8.6844E−05 | 6.7468E−05 | 0.0000E+00 | 0.0000E+00 | 0.0000E+00 | 0.0000E+00 | 0.0000E+00 |
| S4 | −4.2473E−02 | 6.3778E−03 | 0.0000E+00 | 0.0000E+00 | 0.0000E+00 | 0.0000E+00 | 0.0000E+00 |
| S5 | −1.1692E−01 | 1.7675E−02 | 0.0000E+00 | 0.0000E+00 | 0.0000E+00 | 0.0000E+00 | 0.0000E+00 |
| S6 | −3.7441E−04 | −1.6282E−05 | 0.0000E+00 | 0.0000E+00 | 0.0000E+00 | 0.0000E+00 | 0.0000E+00 |
| S7 | 1.0295E−02 | −1.1311E−03 | 0.0000E+00 | 0.0000E+00 | 0.0000E+00 | 0.0000E+00 | 0.0000E+00 |
| S8 | 3.9462E−05 | −6.6540E−06 | 0.0000E+00 | 0.0000E+00 | 0.0000E+00 | 0.0000E+00 | 0.0000E+00 |
| S9 | −3.5435E−03 | 8.8971E−04 | −1.3958E−04 | 1.2614E−05 | −5.0629E−07 | 0.0000E+00 | 0.0000E+00 |
| S10 | −4.5394E−02 | 1.3394E−02 | −2.8193E−03 | 4.1235E−04 | −3.9785E−05 | 2.2760E−06 | −5.8473E−08 |
| S11 | −8.1730E−04 | 1.4582E−04 | −1.8318E−05 | 1.5912E−06 | −9.1140E−08 | 3.0996E−09 | −4.7421E−11 |
| S12 | 5.9390E−05 | −6.5581E−06 | 5.0291E−07 | −2.6293E−08 | 8.9311E−10 | −1.7743E−11 | 1.5622E−13 |
| S13 | −4.8709E−05 | 4.6690E−06 | −3.1598E−07 | 1.4772E−08 | −4.5404E−10 | 8.2593E−12 | −6.7381E−14 |
| S14 | 4.8226E−06 | −3.6008E−07 | 1.9712E−08 | −7.6474E−10 | 1.9844E−11 | −3.0809E−13 | 2.1598E−15 |

FIG. 4A shows a longitudinal aberration curve of the optical imaging system according to embodiment 2 to represent deviation of a convergence focal point after light with different wavelengths passes through the lens. FIG. 4B shows an astigmatism curve of the optical imaging system according to embodiment 2 to represent a tangential image surface curvature and a sagittal image surface curvature. FIG. 4C shows a distortion curve of the optical imaging system according to embodiment 2 to represent distortion values corresponding to different image heights. FIG. 4D shows a lateral color curve of the optical imaging system according to embodiment 2 to represent deviation of different image heights on the imaging surface after the light passes through the lens. According to FIG. 4A to FIG. 4D, it can be seen that the optical imaging system provided in embodiment 2 achieves high imaging quality.

### Embodiment 3

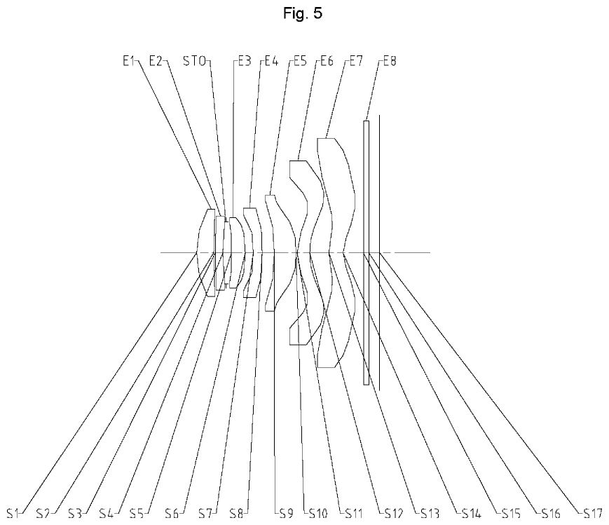

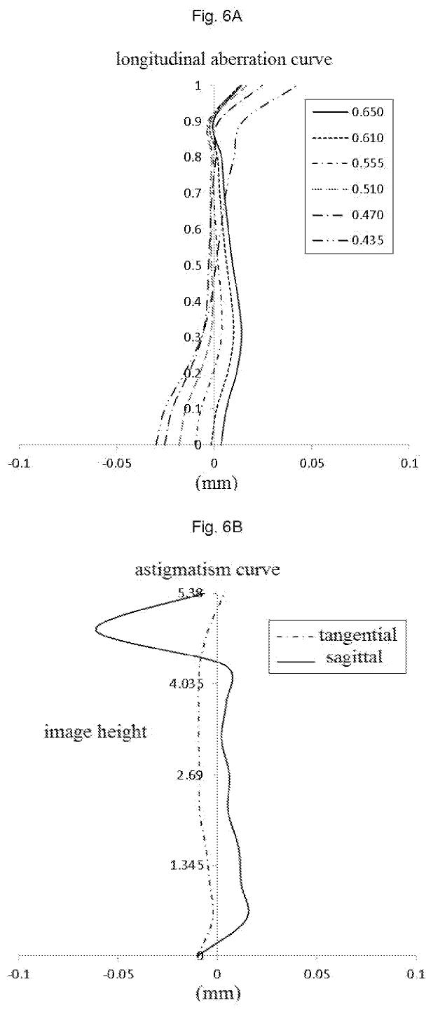

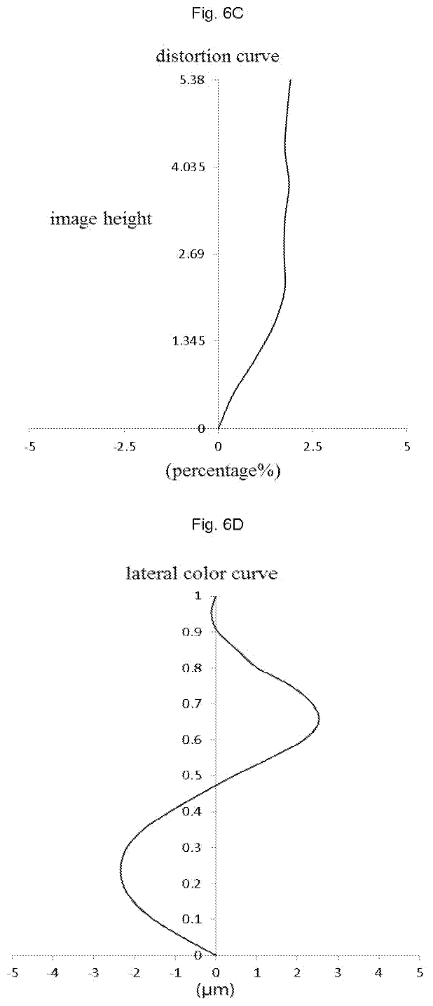

An optical imaging system according to embodiment 3 of the disclosure will be described below with reference to FIG. 5 to FIG. 6D. FIG. 5 is a structure diagram of an optical imaging system according to embodiment 3 of the disclosure.

As shown in FIG. 5, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a positive refractive power, an object-side surface S9 thereof is a concave surface, while an image-side surface S10 is a convex surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.93 mm, a TTL of the optical imaging system is 7.21 mm, ImgH, a half of a diagonal length of an effective pixel region on the imaging surface S17 of the optical imaging system, is 5.38 mm, Semi-FOV, a half of a maximum field of view (FOV) of the optical imaging system, is 46.9°, and Fno, an F-number of the optical imaging system, is 1.90.

Table 5 is a basic parameter table of the optical imaging system of embodiment 3, and units of the radius of curvature, the thickness/distance and the focal length are all mm. Tables 6-1 and 6-2 show high-order coefficients applied to each aspherical mirror surface in embodiment 3. A surface type of each aspherical surface may be defined by formula (1) given in embodiment 1.

TABLE 5

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 3.9159 | 0.6712 | 1.55 | 56.1 | 9.06 | 0.0000 |
| S2 | Aspherical | 17.7167 | 0.0632 | | | | 0.0000 |
| S3 | Aspherical | 6.1548 | 0.3000 | 1.68 | 19.2 | −41.53 | 0.0000 |
| S4 | Aspherical | 4.9501 | 0.1147 | | | | 0.0000 |
| STO | Spherical | Infinite | 0.2228 | | | | |
| S5 | Aspherical | 39.0178 | 0.5400 | 1.55 | 56.1 | 11.37 | 0.0000 |
| S6 | Aspherical | −7.3441 | 0.3169 | | | | 0.0000 |
| S7 | Aspherical | −9.9908 | 0.3500 | 1.68 | 19.2 | −15.84 | 0.0000 |
| S8 | Aspherical | −148.0048 | 0.4813 | | | | 0.0000 |
| S9 | Aspherical | −8.3027 | 0.8585 | 1.55 | 56.1 | 263.16 | 0.0000 |
| S10 | Aspherical | −8.1354 | 0.0400 | | | | 0.0329 |
| S11 | Aspherical | 2.0639 | 0.5000 | 1.55 | 56.1 | 6.27 | −1.0000 |
| S12 | Aspherical | 4.7570 | 0.7534 | | | | 0.0000 |
| S13 | Aspherical | 2.0294 | 0.5599 | 1.54 | 55.7 | −7.10 | −1.0000 |
| S14 | Aspherical | 1.1966 | 0.8029 | | | | −1.0000 |
| S15 | Spherical | Infinite | 0.2100 | 1.62 | 64.2 | | |
| S16 | Spherical | Infinite | 0.4262 | | | | |
| S17 | Spherical | Infinite | | | | | |

TABLE 6-1

| Surface | | | | | | | |
|---|---|---|---|---|---|---|---|
| number | A4 | A6 | A8 | A10 | A12 | A14 | A16 |
| S1 | 9.5612E−04 | 6.1049E−03 | −1.2900E−02 | 1.9572E−02 | −1.8246E−02 | 1.0670E−02 | −3.8016E−03 |
| S2 | −3.6388E−02 | 6.0889E−02 | −6.0192E−02 | 3.6024E−02 | −6.6344E−03 | −7.2118E−03 | 5.8315E−03 |
| S3 | −7.8607E−02 | 6.5753E−02 | −6.6441E−02 | 5.4450E−02 | −3.2619E−02 | 1.3118E−02 | −2.7344E−03 |
| S4 | −5.8993E−02 | 7.0819E−03 | 3.4869E−02 | −1.1182E−01 | 1.9115E−01 | −1.9622E−01 | 1.2275E−01 |
| S5 | −2.4064E−02 | −3.0850E−02 | 9.1509E−02 | −2.6137E−01 | 4.5534E−01 | −4.8703E−01 | 3.1346E−01 |
| S6 | −3.1950E−02 | −2.6468E−02 | 2.0363E−02 | −2.1836E−02 | 1.5571E−02 | −4.1014E−03 | −1.4628E−03 |
| S7 | −5.1952E−02 | −1.4778E−02 | −2.1009E−02 | 5.7689E−02 | −7.3891E−02 | 6.3559E−02 | −3.2871E−02 |
| S8 | −2.9439E−02 | −7.7965E−03 | 1.2306E−03 | −4.4725E−04 | 2.8993E−03 | −1.7376E−03 | 3.3977E−04 |
| S9 | −8.2385E−03 | 1.8198E−02 | −1.8534E−02 | 2.0593E−03 | 1.1929E−02 | −1.4393E−02 | 9.0153E−03 |
| S10 | −1.4476E−01 | 4.7406E−02 | 9.3328E−02 | −2.2392E−01 | 2.6986E−01 | −2.1611E−01 | 1.2201E−01 |
| S11 | −1.5766E−02 | −6.1571E−03 | 6.4510E−03 | −1.6705E−02 | 1.7068E−02 | −9.8128E−03 | 3.6529E−03 |
| S12 | 1.5325E−01 | −1.0880E−01 | 3.2790E−02 | −1.5797E−03 | −2.8755E−03 | 1.3436E−03 | −3.3303E−04 |
| S13 | −1.5286E−01 | 2.9881E−02 | 1.2017E−02 | −1.3691E−02 | 6.3431E−03 | −1.8206E−03 | 3.5339E−04 |
| S14 | −2.1327E−01 | 9.2938E−02 | −3.4056E−02 | 9.8088E−03 | −2.1903E−03 | 3.7707E−04 | −4.9714E−05 |

TABLE 6-2

| Surface | | | | | | | |
|---|---|---|---|---|---|---|---|
| number | A18 | A20 | A22 | A24 | A26 | A28 | A30 |
| S1 | 7.5284E−04 | −6.3707E−05 | 0.0000E+00 | 0.0000E+00 | 0.0000E+00 | 0.0000E+00 | 0.0000E+00 |
| S2 | −1.7248E−03 | 1.8729E−04 | 0.0000E+00 | 0.0000E+00 | 0.0000E+00 | 0.0000E+00 | 0.0000E+00 |
| S3 | 7.0607E−05 | 4.7699E−05 | 0.0000E+00 | 0.0000E+00 | 0.0000E+00 | 0.0000E+00 | 0.0000E+00 |
| S4 | −4.2921E−02 | 6.4283E−03 | 0.0000E+00 | 0.0000E+00 | 0.0000E+00 | 0.0000E+00 | 0.0000E+00 |
| S5 | −1.1130E−01 | 1.6662E−02 | 0.0000E+00 | 0.0000E+00 | 0.0000E+00 | 0.0000E+00 | 0.0000E+00 |
| S6 | 1.0709E−03 | −1.9046E−04 | 0.0000E+00 | 0.0000E+00 | 0.0000E+00 | 0.0000E+00 | 0.0000E+00 |
| S7 | 8.9985E−03 | −9.9521E−04 | 0.0000E+00 | 0.0000E+00 | 0.0000E+00 | 0.0000E+00 | 0.0000E+00 |
| S8 | −4.5823E−06 | −3.4455E−06 | 0.0000E+00 | 0.0000E+00 | 0.0000E+00 | 0.0000E+00 | 0.0000E+00 |
| S9 | −3.4960E−03 | 8.6940E−04 | −1.3620E−04 | 1.2354E−05 | −4.9949E−07 | 0.0000E+00 | 0.0000E+00 |
| S10 | −4.9528E−02 | 1.4497E−02 | −3.0281E−03 | 4.3960E−04 | −4.2109E−05 | 2.3921E−06 | −6.1036E−08 |
| S11 | −9.3386E−04 | 1.6790E−04 | −2.1267E−05 | 1.8619E−06 | −1.0738E−07 | 3.6727E−09 | −5.6441E−11 |
| S12 | 5.3867E−05 | −5.9858E−06 | 4.6082E−07 | −2.4148E−08 | 8.2121E−10 | −1.6319E−11 | 1.4361E−13 |
| S13 | −4.8013E−05 | 4.6231E−06 | −3.1432E−07 | 1.4763E−08 | −4.5600E−10 | 8.3366E−12 | −6.8363E−14 |
| S14 | 4.9746E−06 | −3.7275E−07 | 2.0479E−08 | −7.9738E−10 | 2.0767E−11 | −3.2362E−13 | 2.2771E−15 |

FIG. 6A shows a longitudinal aberration curve of the optical imaging system according to embodiment 3 to represent deviation of a convergence focal point after light with different wavelengths passes through the lens. FIG. 6B shows an astigmatism curve of the optical imaging system according to embodiment 3 to represent a tangential image surface curvature and a sagittal image surface curvature. FIG. 6C shows a distortion curve of the optical imaging system according to embodiment 3 to represent distortion values corresponding to different image heights. FIG. 6D shows a lateral color curve of the optical imaging system according to embodiment 3 to represent deviation of different image heights on the imaging surface after the light passes through the lens. According to FIG. 6A to FIG. 6D, it can be seen that the optical imaging system provided in embodiment 3 achieves high imaging quality.

### Embodiment 4

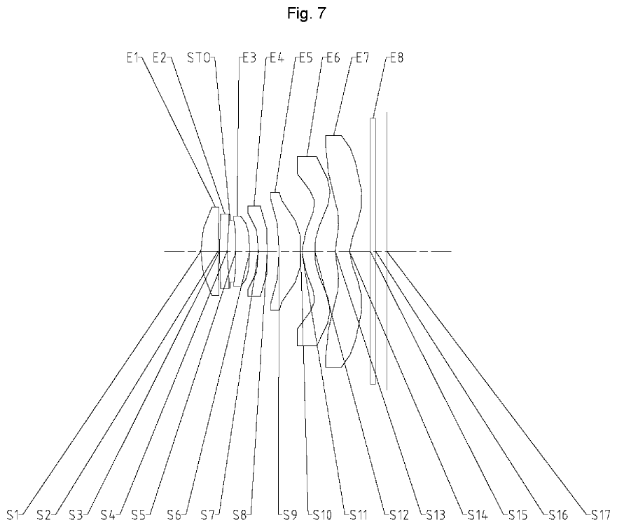

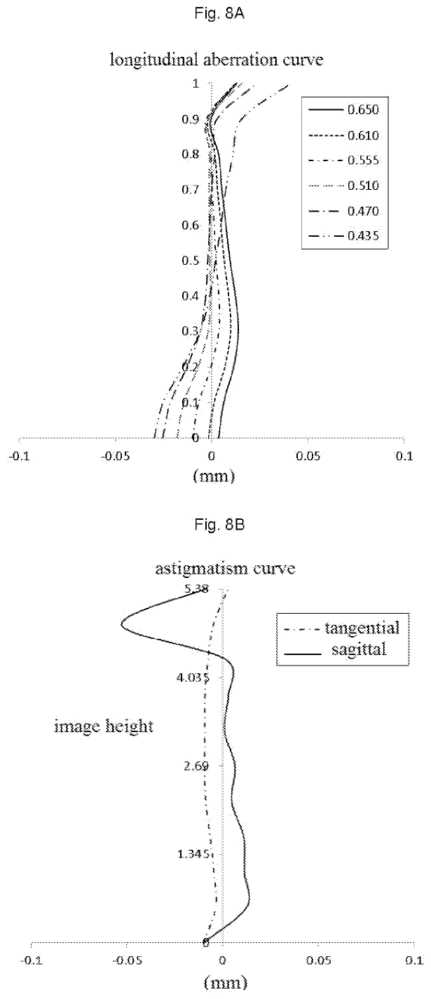

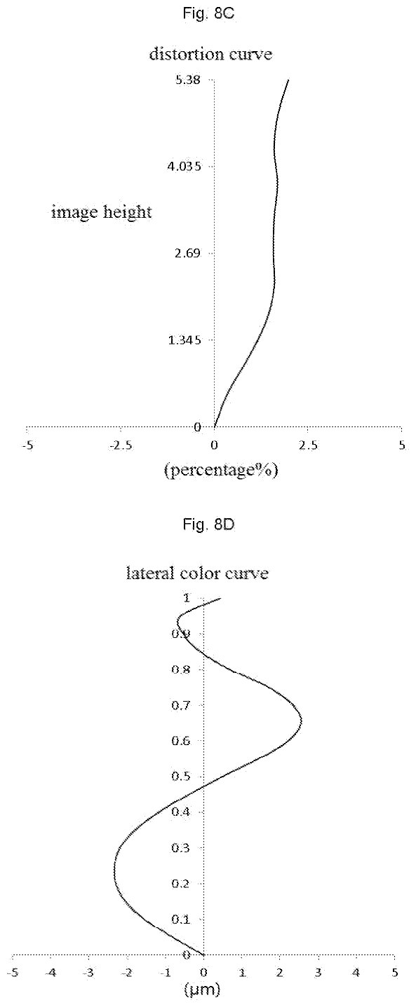

An optical imaging system according to embodiment 4 of the disclosure will be described below with reference to FIG. 7 to FIG. 8D. FIG. 7 is a structure diagram of an optical imaging system according to embodiment 4 of the disclosure.

As shown in FIG. 7, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a negative refractive power, an object-side surface S9 thereof is a concave surface, while an image-side surface S10 is a concave surface. The sixth lens E6 has a positive refractive power, an object-side surface 511 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.93 mm, a TTL of the optical imaging system is 7.24 mm, ImgH, a half of a diagonal length of an effective pixel region on the imaging surface S17 of the optical imaging system, is 5.38 mm, Semi-FOV, a half of a maximum FOV of the optical imaging system, is 46.9°, and Fno, an F-number of the optical imaging system, is 1.90.

Table 7 is a basic parameter table of the optical imaging system of embodiment 4, and units of the radius of curvature, the thickness/distance and the focal length are all mm. Tables 8-1 and 8-2 show high-order coefficients applied to each aspherical mirror surface in embodiment 4. A surface type of each aspherical surface is defined by formula (1) given in embodiment 1.

TABLE 7

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 3.9449 | 0.6683 | 1.55 | 56.1 | 9.30 | 0.0000 |
| S2 | Aspherical | 16.6770 | 0.0599 | | | | 0.0000 |
| S3 | Aspherical | 5.9207 | 0.3000 | 1.68 | 19.2 | −43.52 | 0.0000 |
| S4 | Aspherical | 4.8290 | 0.1192 | | | | 0.0000 |
| STO | Spherical | Infinite | 0.2205 | | | | |
| S5 | Aspherical | 40.1657 | 0.5383 | 1.55 | 56.1 | 11.51 | 0.0000 |
| S6 | Aspherical | −7.4089 | 0.3333 | | | | 0.0000 |
| S7 | Aspherical | −8.8959 | 0.3500 | 1.68 | 19.2 | −15.40 | 0.0000 |
| S8 | Aspherical | −61.5466 | 0.4535 | | | | 0.0000 |
| S9 | Aspherical | −9.1460 | 0.8457 | 1.55 | 56.1 | −13.81 | 0.0000 |
| S10 | Aspherical | 44.2158 | 0.0400 | | | | −0.1489 |
| S11 | Aspherical | 1.6870 | 0.5060 | 1.55 | 56.1 | 4.15 | −1.0000 |
| S12 | Aspherical | 5.9232 | 0.7930 | | | | 0.0000 |
| S13 | Aspherical | 2.0124 | 0.5597 | 1.54 | 55.7 | −7.01 | −1.0000 |
| S14 | Aspherical | 1.1837 | 0.8094 | | | | −1.0000 |
| S15 | Spherical | Infinite | 0.2100 | 1.62 | 64.2 | | |
| S16 | Spherical | Infinite | 0.4331 | | | | |
| S17 | Spherical | Infinite | | | | | |

TABLE 8-1

| Surface | | | | | | | |
|---|---|---|---|---|---|---|---|
| number | A4 | A6 | A8 | A10 | A12 | A14 | A16 |
| S1 | 1.0856E−03 | 6.8162E−03 | −1.4323E−02 | 2.1228E−02 | −1.9410E−02 | 1.1159E−02 | −3.9169E−03 |
| S2 | −3.8504E−02 | 6.4423E−02 | −6.3271E−02 | 3.6495E−02 | −4.8173E−03 | −9.2024E−03 | 6.7930E−03 |
| S3 | −8.0369E−02 | 6.8596E−02 | −6.8794E−02 | 5.4412E−02 | −2.9948E−02 | 9.8889E−03 | −8.7432E−04 |
| S4 | −5.8565E−02 | 6.5034E−03 | 3.5618E−02 | −1.1074E−01 | 1.8673E−01 | −1.9037E−01 | 1.1861E−01 |
| S5 | −2.5141E−02 | −2.8990E−02 | 8.4500E−02 | −2.4410E−01 | 4.2754E−01 | −4.5851E−01 | 2.9545E−01 |
| S6 | −3.2329E−02 | −2.5849E−02 | 2.0643E−02 | −2.4306E−02 | 1.9690E−02 | −7.6616E−03 | 2.6394E−04 |
| S7 | −5.0184E−02 | −1.5694E−02 | −2.1431E−02 | 5.8949E−02 | −7.5830E−02 | 6.5206E−02 | −3.3546E−02 |
| S8 | −2.7536E−02 | −9.2972E−03 | 2.9405E−03 | −3.0444E−03 | 5.0442E−03 | −2.7483E−03 | 6.2791E−04 |
| S9 | −7.8948E−03 | 1.3026E−02 | −7.6353E−03 | −7.7300E−03 | 1.4827E−02 | −1.2102E−02 | 6.1172E−03 |
| S10 | −2.6056E−01 | 1.8423E−01 | −2.8757E−02 | −1.3645E−01 | 2.1544E−01 | −1.8505E−01 | 1.0622E−01 |
| S11 | −9.7405E−02 | 1.0475E−01 | −1.0184E−01 | 6.1843E−02 | −2.5290E−02 | 7.1338E−03 | −1.3764E−03 |
| S12 | 1.9300E−01 | −1.4740E−01 | 6.1007E−02 | −1.6288E−02 | 2.5583E−03 | −9.7443E−05 | −5.5263E−05 |
| S13 | −1.5082E−01 | 2.7771E−02 | 1.1824E−02 | −1.2576E−02 | 5.6340E−03 | −1.5795E−03 | 3.0103E−04 |
| S14 | −2.1406E−01 | 9.2697E−02 | −3.3752E−02 | 9.6838E−03 | −2.1558E−03 | 3.6996E−04 | −4.8619E−05 |

TABLE 8-2

| Surface | | | | | | | |
|---|---|---|---|---|---|---|---|
| number | A18 | A20 | A22 | A24 | A26 | A28 | A30 |
| S1 | 7.6530E−04 | −6.3945E−05 | 0.0000E+00 | 0.0000E+00 | 0.0000E+00 | 0.0000E+00 | 0.0000E+00 |
| S2 | −1.9533E−03 | 2.0910E−04 | 0.0000E+00 | 0.0000E+00 | 0.0000E+00 | 0.0000E+00 | 0.0000E+00 |
| S3 | −4.6758E−04 | 1.1029E−04 | 0.0000E+00 | 0.0000E+00 | 0.0000E+00 | 0.0000E+00 | 0.0000E+00 |
| S4 | −4.1354E−02 | 6.1766E−03 | 0.0000E+00 | 0.0000E+00 | 0.0000E+00 | 0.0000E+00 | 0.0000E+00 |
| S5 | −1.0492E−01 | 1.5694E−02 | 0.0000E+00 | 0.0000E+00 | 0.0000E+00 | 0.0000E+00 | 0.0000E+00 |
| S6 | 6.3182E−04 | −1.4604E−04 | 0.0000E+00 | 0.0000E+00 | 0.0000E+00 | 0.0000E+00 | 0.0000E+00 |
| S7 | 9.1103E−03 | −9.9861E−04 | 0.0000E+00 | 0.0000E+00 | 0.0000E+00 | 0.0000E+00 | 0.0000E+00 |
| S8 | −5.2065E−05 | 1.7251E−08 | 0.0000E+00 | 0.0000E+00 | 0.0000E+00 | 0.0000E+00 | 0.0000E+00 |
| S9 | −2.0028E−03 | 4.2244E−04 | −5.5379E−05 | 4.1168E−06 | −1.3412E−07 | 0.0000E+00 | 0.0000E+00 |
| S10 | −4.2959E−02 | 1.2418E−02 | −2.5518E−03 | 3.6395E−04 | −3.4250E−05 | 1.9129E−06 | −4.8057E−08 |
| S11 | 1.7163E−04 | −1.0941E−05 | −2.9015E−07 | 1.2900E−07 | −1.1871E−08 | 5.2294E−10 | −9.4619E−12 |
| S12 | 1.4716E−05 | −1.9599E−06 | 1.6255E−07 | −8.6566E−09 | 2.8603E−10 | −5.2731E−12 | 4.0495E−14 |
| S13 | −4.0270E−05 | 3.8236E−06 | −2.5652E−07 | 1.1892E−08 | −3.6258E−10 | 6.5422E−12 | −5.2941E−14 |
| S14 | 4.8498E−06 | −3.6231E−07 | 1.9848E−08 | −7.7064E−10 | 2.0015E−11 | −3.1104E−13 | 2.1828E−15 |

FIG. 8A shows a longitudinal aberration curve of the optical imaging system according to embodiment 4 to represent deviation of a convergence focal point after light with different wavelengths passes through the lens. FIG. 8B shows an astigmatism curve of the optical imaging system according to embodiment 4 to represent a tangential image surface curvature and a sagittal image surface curvature. FIG. 8C shows a distortion curve of the optical imaging system according to embodiment 4 to represent distortion values corresponding to different image heights. FIG. 8D shows a lateral color curve of the optical imaging system according to embodiment 4 to represent deviation of different image heights on the imaging surface after the light passes through the lens. According to FIG. 8A to FIG. 8D, it can be seen that the optical imaging system provided in embodiment 4 achieves high imaging quality.

### Embodiment 5

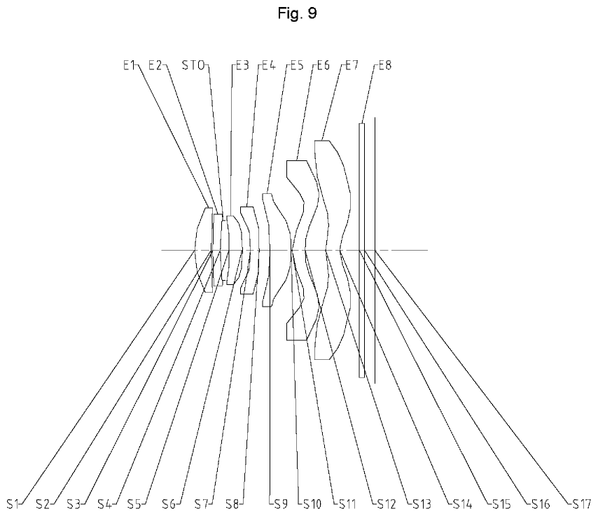

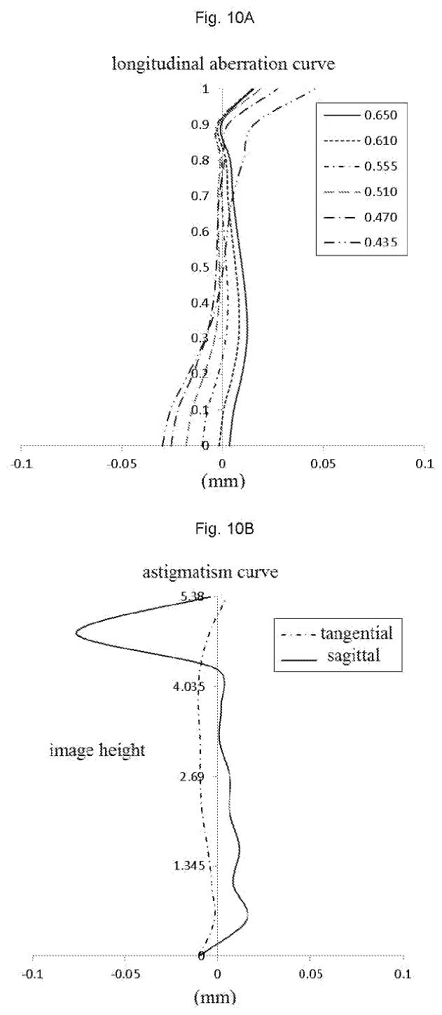

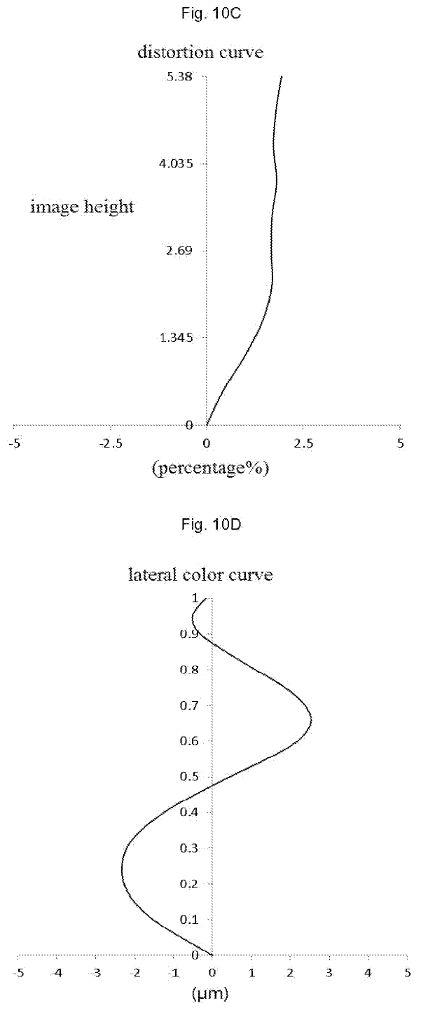

An optical imaging system according to embodiment 5 of the disclosure will be described below with reference to FIG. 9 to FIG. 10D. FIG. 9 is a structure diagram of an optical imaging system according to embodiment 5 of the disclosure.

As shown in FIG. 9, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a negative refractive power, an object-side surface S9 thereof is a concave surface, while an image-side surface S10 is a concave surface. The sixth lens E6 has a positive refractive power, an object-side surface 511 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.95 mm, a TTL of the optical imaging system is 7.25 mm, ImgH is 5.38 mm, wherein ImgH is a half of a diagonal length of an effective pixel region on the imaging surface S17 of the optical imaging system, Semi-FOV is 46.8°, wherein Semi-FOV is a half of a maximum field of view of the optical imaging system, and Fno, an F-number of the optical imaging system, is 1.90.

Table 9 is a basic parameter table of the optical imaging system of embodiment 5, and units of the radius of curvature, the thickness/distance and the focal length are all mm. Tables 10-1 and 10-2 show high-order coefficients applied to each aspherical mirror surface in embodiment 5. A surface type of each aspherical surface is defined by formula (1) given in embodiment 1.

TABLE 9

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 4.0024 | 0.6655 | 1.55 | 56.1 | 9.26 | 0.0000 |
| S2 | Aspherical | 18.0972 | 0.0636 | | | | 0.0000 |
| S3 | Aspherical | 6.0569 | 0.3000 | 1.68 | 19.2 | −40.30 | 0.0000 |
| S4 | Aspherical | 4.8575 | 0.1183 | | | | 0.0000 |
| STO | Spherical | Infinite | 0.2283 | | | | |
| S5 | Aspherical | 26.1629 | 0.5470 | 1.55 | 56.1 | 11.74 | 0.0000 |
| S6 | Aspherical | −8.4240 | 0.3226 | | | | 0.0000 |
| S7 | Aspherical | −10.4979 | 0.3500 | 1.68 | 19.2 | −16.06 | 0.0000 |
| S8 | Aspherical | −308.5411 | 0.4343 | | | | 0.0000 |
| S9 | Aspherical | −9.2442 | 0.8448 | 1.55 | 56.1 | −11.49 | 0.0000 |
| S10 | Aspherical | 20.1352 | 0.0400 | | | | −0.2407 |
| S11 | Aspherical | 1.5882 | 0.5252 | 1.55 | 56.1 | 3.93 | −1.0000 |
| S12 | Aspherical | 5.4178 | 0.8281 | | | | 0.0000 |
| S13 | Aspherical | 2.0859 | 0.5598 | 1.54 | 55.7 | −6.87 | −1.0000 |
| S14 | Aspherical | 1.2073 | 0.7937 | | | | −1.0000 |
| S15 | Spherical | Infinite | 0.2100 | 1.62 | 64.2 | | |
| S16 | Spherical | Infinite | 0.4148 | | | | |
| S17 | Spherical | Infinite | | | | | |

TABLE 10-1

| Surface | | | | | | | |
|---|---|---|---|---|---|---|---|
| number | A4 | A6 | A8 | A10 | A12 | A14 | A16 |
| S1 | 1.9142E−03 | 4.6090E−03 | −8.7379E−03 | 1.3458E−02 | −1.2746E−02 | 7.5912E−03 | −2.7557E−03 |
| S2 | −3.4534E−02 | 6.5638E−02 | −7.2367E−02 | 5.2822E−02 | −2.1784E−02 | 1.6908E−03 | 2.5430E−03 |
| S3 | −7.8924E−02 | 7.2833E−02 | −8.2174E−02 | 7.6031E−02 | −5.2879E−02 | 2.5871E−02 | −7.8604E−03 |
| S4 | −6.0932E−02 | 1.1893E−02 | 2.7390E−02 | −1.0135E−01 | 1.7951E−01 | −1.8626E−01 | 1.1648E−01 |
| S5 | −2.5753E−02 | −2.5036E−02 | 6.8227E−02 | −1.8824E−01 | 3.1768E−01 | −3.2931E−01 | 2.0540E−01 |
| S6 | −3.3322E−02 | −2.4287E−02 | 1.7652E−02 | −1.6503E−02 | 8.7089E−03 | 1.0792E−03 | −3.7605E−03 |
| S7 | −5.0542E−02 | −2.2237E−02 | 4.0722E−03 | 1.3365E−02 | −2.3850E−02 | 2.6927E−02 | −1.6277E−02 |
| S8 | −2.6233E−02 | −1.5913E−02 | 1.5449E−02 | −1.5472E−02 | 1.3090E−02 | −6.2963E−03 | 1.6434E−03 |
| S9 | 7.7549E−03 | −1.6890E−02 | 3.6713E−02 | −5.7434E−02 | 5.6445E−02 | −3.7707E−02 | 1.7607E−02 |
| S10 | −2.4672E−01 | 1.3240E−01 | 6.4597E−02 | −2.5130E−01 | 3.1720E−01 | −2.5095E−01 | 1.3762E−01 |
| S11 | −1.1049E−01 | 9.9913E−02 | −8.1667E−02 | 3.8356E−02 | −8.7088E−03 | −8.8429E−04 | 1.3873E−03 |
| S12 | 1.7390E−01 | −1.3113E−01 | 5.1827E−02 | −1.2680E−02 | 1.5156E−03 | 1.3104E−04 | −9.3556E−05 |
| S13 | −1.6074E−01 | 3.2778E−02 | 1.0776E−02 | −1.2694E−02 | 5.8055E−03 | −1.6433E−03 | 3.1523E−04 |
| S14 | −2.1797E−01 | 9.6521E−02 | −3.5744E−02 | 1.0416E−02 | −2.3551E−03 | 4.1052E−04 | −5.4800E−05 |

TABLE 10-2

| Surface | | | | | | | |
|---|---|---|---|---|---|---|---|
| number | A18 | A20 | A22 | A24 | A26 | A28 | A30 |
| S1 | 5.5506E−04 | −4.7733E−05 | 0.0000E+00 | 0.0000E+00 | 0.0000E+00 | 0.0000E+00 | 0.0000E+00 |
| S2 | −1.0327E−03 | 1.2438E−04 | 0.0000E+00 | 0.0000E+00 | 0.0000E+00 | 0.0000E+00 | 0.0000E+00 |
| S3 | 1.2626E−03 | −7.4913E−05 | 0.0000E+00 | 0.0000E+00 | 0.0000E+00 | 0.0000E+00 | 0.0000E+00 |
| S4 | −4.0441E−02 | 5.9822E−03 | 0.0000E+00 | 0.0000E+00 | 0.0000E+00 | 0.0000E+00 | 0.0000E+00 |
| S5 | −7.0637E−02 | 1.0201E−02 | 0.0000E+00 | 0.0000E+00 | 0.0000E+00 | 0.0000E+00 | 0.0000E+00 |
| S6 | 1.6503E−03 | −2.5669E−04 | 0.0000E+00 | 0.0000E+00 | 0.0000E+00 | 0.0000E+00 | 0.0000E+00 |
| S7 | 4.8172E−03 | −5.5109E−04 | 0.0000E+00 | 0.0000E+00 | 0.0000E+00 | 0.0000E+00 | 0.0000E+00 |
| S8 | −2.1878E−04 | 1.1753E−05 | 0.0000E+00 | 0.0000E+00 | 0.0000E+00 | 0.0000E+00 | 0.0000E+00 |
| S9 | −5.7221E−03 | 1.2680E−03 | −1.8320E−04 | 1.5618E−05 | −5.9877E−07 | 0.0000E+00 | 0.0000E+00 |
| S10 | −5.3951E−02 | 1.5226E−02 | −3.0669E−03 | 4.2979E−04 | −3.9798E−05 | 2.1892E−06 | −5.4190E−08 |
| S11 | −5.1688E−04 | 1.1308E−04 | −1.6254E−05 | 1.5584E−06 | −9.6335E−08 | 3.4819E−09 | −5.5978E−11 |
| S12 | 1.9586E−05 | −2.4204E−06 | 1.9393E−07 | −1.0124E−08 | 3.2960E−10 | −5.9774E−12 | 4.4680E−14 |
| S13 | −4.2412E−05 | 4.0513E−06 | −2.7366E−07 | 1.2788E−08 | −3.9339E−10 | 7.1701E−12 | −5.8670E−14 |
| S14 | 5.5530E−06 | −4.2146E−07 | 2.3459E−08 | −9.2562E−10 | 2.4434E−11 | −3.8604E−13 | 2.7548E−15 |

FIG. 10A shows a longitudinal aberration curve of the optical imaging system according to embodiment 5 to represent deviation of a convergence focal point after light with different wavelengths passes through the lens. FIG. 10B shows an astigmatism curve of the optical imaging system according to embodiment 5 to represent a tangential image surface curvature and a sagittal image surface curvature. FIG. 10C shows a distortion curve of the optical imaging system according to embodiment 5 to represent distortion values corresponding to different image heights. FIG. 10D shows a lateral color curve of the optical imaging system according to embodiment 5 to represent deviation of different image heights on the imaging surface after the light passes through the lens. According to FIG. 10A to FIG. 10D, it can be seen that the optical imaging system provided in embodiment 5 achieves high imaging quality.

### Embodiment 6

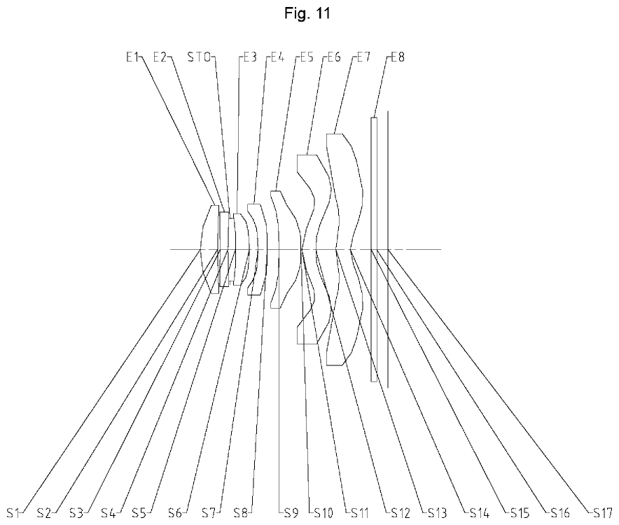

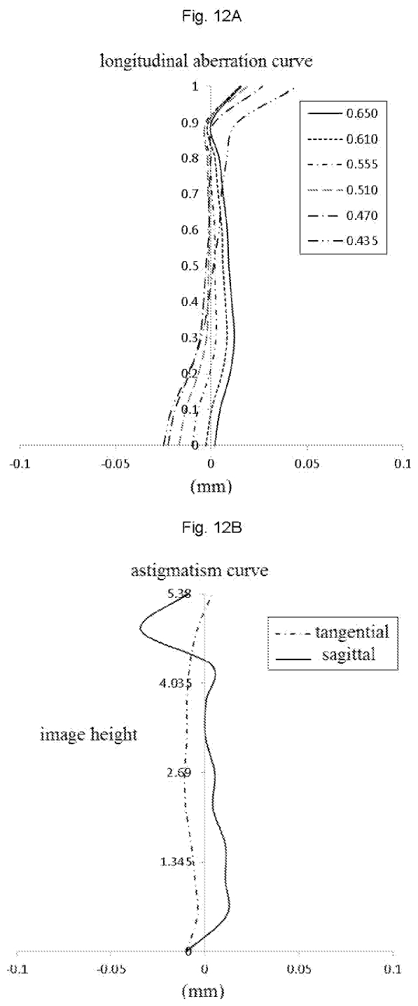

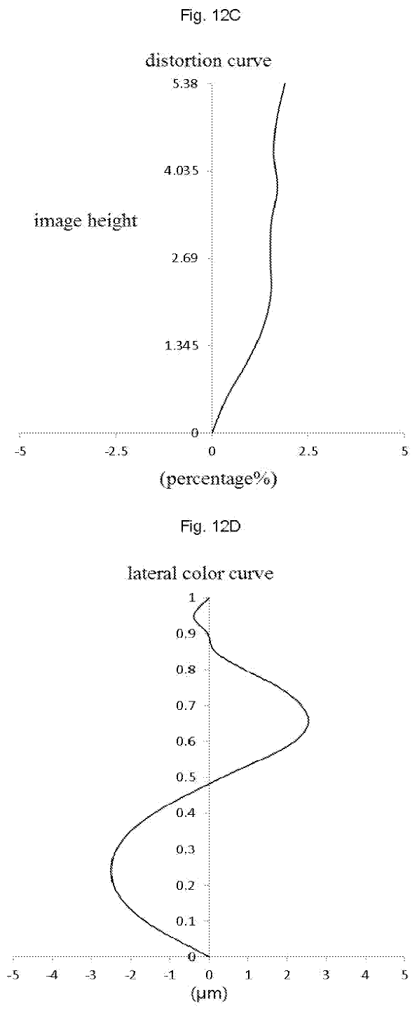

An optical imaging system according to embodiment 6 of the disclosure will be described below with reference to FIG. 11 to FIG. 12D. FIG. 11 illustrates a structure diagram of an optical imaging system according to embodiment 6 of the disclosure.

As shown in FIG. 11, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a concave surface. The fifth lens E5 has a negative refractive power, an object-side surface S9 thereof is a concave surface, while an image-side surface S10 is a concave surface. The sixth lens E6 has a positive refractive power, an object-side surface 511 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.95 mm, a TTL of the optical imaging system is 7.27 mm, ImgH, a half of a diagonal length of an effective pixel region on the imaging surface S17 of the optical imaging system, is 5.38 mm, Semi-FOV, a half of a maximum FOV of the optical imaging system, is 46.8°, and Fno, an F-number of the optical imaging system, is 1.90.

Table 11 is a basic parameter table of the optical imaging system of embodiment 6, and units of the radius of curvature, the thickness/distance and the focal length are all mm. Tables 12-1 and 12-2 show high-order coefficients applied to each aspherical mirror surface in embodiment 6. A surface type of each aspherical surface is defined by formula (1) given in embodiment 1.

TABLE 11

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 3.9304 | 0.6650 | 1.55 | 56.1 | 9.44 | 0.0000 |
| S2 | Aspherical | 15.5966 | 0.1055 | | | | 0.0000 |
| S3 | Aspherical | 7.7596 | 0.3000 | 1.68 | 19.2 | −36.62 | 0.0000 |
| S4 | Aspherical | 5.8176 | 0.0830 | | | | 0.0000 |
| STO | Spherical | Infinite | 0.2068 | | | | |
| S5 | Aspherical | 17.7137 | 0.5380 | 1.55 | 56.1 | 11.20 | 0.0000 |
| S6 | Aspherical | −9.2249 | 0.3453 | | | | 0.0000 |
| S7 | Aspherical | −10.5395 | 0.3500 | 1.68 | 19.2 | −15.48 | 0.0000 |
| S8 | Aspherical | 1941.8005 | 0.4743 | | | | 0.0000 |
| S9 | Aspherical | −10.1023 | 0.8309 | 1.55 | 56.1 | −9.96 | 0.0000 |
| S10 | Aspherical | 12.1163 | 0.0400 | | | | −0.1360 |
| S11 | Aspherical | 1.5786 | 0.5373 | 1.55 | 56.1 | 3.67 | −1.0000 |
| S12 | Aspherical | 6.5894 | 0.7776 | | | | 0.0000 |
| S13 | Aspherical | 2.0402 | 0.5615 | 1.54 | 55.7 | −6.86 | −1.0000 |
| S14 | Aspherical | 1.1865 | 0.8089 | | | | −1.0000 |
| S15 | Spherical | Infinite | 0.2100 | 1.62 | 64.2 | | |
| S16 | Spherical | Infinite | 0.4361 | | | | |
| S17 | Spherical | Infinite | | | | | |

TABLE 12-1

| Surface | | | | | | | |
|---|---|---|---|---|---|---|---|
| number | A4 | A6 | A8 | A10 | A12 | A14 | A16 |
| S1 | 2.9970E−04 | 5.9299E−03 | −1.2111E−02 | 1.8415E−02 | −1.7266E−02 | 1.0139E−02 | −3.6188E−03 |
| S2 | −2.8707E−02 | 3.4491E−02 | −1.7437E−02 | −9.7380E−03 | 2.7304E−02 | −2.4359E−02 | 1.1388E−02 |
| S3 | −7.8479E−02 | 4.9139E−02 | −3.1522E−02 | 1.6031E−02 | −5.5723E−03 | 5.4682E−04 | 9.8067E−04 |
| S4 | −7.0404E−02 | 1.4090E−02 | 3.1591E−02 | −9.8816E−02 | 1.5831E−01 | −1.5351E−01 | 9.1575E−02 |
| S5 | −2.9723E−02 | −2.0373E−02 | 5.2960E−02 | −1.6494E−01 | 3.0286E−01 | −3.2953E−01 | 2.1137E−01 |
| S6 | −2.9230E−02 | −3.2071E−02 | 3.9536E−02 | −6.2595E−02 | 6.7600E−02 | −4.4871E−02 | 1.7768E−02 |
| S7 | −5.2296E−02 | −2.2181E−02 | −2.3351E−03 | 2.6002E−02 | −3.9450E−02 | 3.8877E−02 | −2.1406E−02 |
| S8 | −2.9352E−02 | −1.5653E−02 | 1.5186E−02 | −1.6196E−02 | 1.4278E−02 | −6.9508E−03 | 1.8374E−03 |
| S9 | −2.2426E−03 | −7.5952E−04 | 1.7533E−02 | −4.1220E−02 | 4.7137E−02 | −3.4436E−02 | 1.7102E−02 |
| S10 | −2.8995E−01 | 2.1114E−01 | −5.7301E−02 | −9.3500E−02 | 1.5914E−01 | −1.3347E−01 | 7.3678E−02 |
| S11 | −1.2782E−01 | 1.3392E−01 | −1.2331E−01 | 7.5588E−02 | −3.2886E−02 | 1.0499E−02 | −2.5076E−03 |
| S12 | 1.9857E−01 | −1.5362E−01 | 6.8615E−02 | −2.1822E−02 | 5.1224E−03 | −9.0332E−04 | 1.2269E−04 |
| S13 | −1.4820E−01 | 2.4669E−02 | 1.4517E−02 | −1.3839E−02 | 6.0003E−03 | −1.6442E−03 | 3.0691E−04 |
| S14 | −2.1383E−01 | 9.2570E−02 | −3.3574E−02 | 9.5933E−03 | −2.1274E−03 | 3.6375E−04 | −4.7645E−05 |

TABLE 12-2

| Surface | | | | | | | |
|---|---|---|---|---|---|---|---|
| number | A18 | A20 | A22 | A24 | A26 | A28 | A30 |
| S1 | 7.1589E−04 | −6.0406E−05 | 0.0000E+00 | 0.0000E+00 | 0.0000E+00 | 0.0000E+00 | 0.0000E+00 |
| S2 | −2.7620E−03 | 2.7244E−04 | 0.0000E+00 | 0.0000E+00 | 0.0000E+00 | 0.0000E+00 | 0.0000E+00 |
| S3 | −5.5624E−04 | 9.2590E−05 | 0.0000E+00 | 0.0000E+00 | 0.0000E+00 | 0.0000E+00 | 0.0000E+00 |
| S4 | −3.0765E−02 | 4.4467E−03 | 0.0000E+00 | 0.0000E+00 | 0.0000E+00 | 0.0000E+00 | 0.0000E+00 |
| S5 | −7.3890E−02 | 1.0781E−02 | 0.0000E+00 | 0.0000E+00 | 0.0000E+00 | 0.0000E+00 | 0.0000E+00 |
| S6 | −3.9181E−03 | 3.5407E−04 | 0.0000E+00 | 0.0000E+00 | 0.0000E+00 | 0.0000E+00 | 0.0000E+00 |
| S7 | 5.9226E−03 | −6.4276E−04 | 0.0000E+00 | 0.0000E+00 | 0.0000E+00 | 0.0000E+00 | 0.0000E+00 |
| S8 | −2.5345E−04 | 1.4647E−05 | 0.0000E+00 | 0.0000E+00 | 0.0000E+00 | 0.0000E+00 | 0.0000E+00 |
| S9 | −5.8122E−03 | 1.3327E−03 | −1.9795E−04 | 1.7288E−05 | −6.7785E−07 | 0.0000E+00 | 0.0000E+00 |
| S10 | −2.8579E−02 | 7.9290E−03 | −1.5661E−03 | 2.1506E−04 | −1.9521E−05 | 1.0542E−06 | −2.5687E−08 |
| S11 | 4.5180E−04 | −6.1183E−05 | 6.1168E−06 | −4.3565E−07 | 2.0766E−08 | −5.8930E−10 | 7.4668E−12 |
| S12 | −1.3332E−05 | 1.2011E−06 | −8.9389E−08 | 5.1700E−09 | −2.0965E−10 | 5.1504E−12 | −5.6774E−14 |
| S13 | −4.0240E−05 | 3.7475E−06 | −2.4685E−07 | 1.1250E−08 | −3.3761E−10 | 6.0039E−12 | −4.7939E−14 |
| S14 | 4.7385E−06 | −3.5302E−07 | 1.9288E−08 | −7.4698E−10 | 1.9349E−11 | −2.9989E−13 | 2.0985E−15 |

FIG. 12A shows a longitudinal aberration curve of the optical imaging system according to embodiment 6 to represent deviation of a convergence focal point after light with different wavelengths passes through the lens. FIG. 12B shows an astigmatism curve of the optical imaging system according to embodiment 6 to represent a tangential image surface curvature and a sagittal image surface curvature. FIG. 12C shows a distortion curve of the optical imaging system according to embodiment 6 to represent distortion values corresponding to different image heights. FIG. 12D shows a lateral color curve of the optical imaging system according to embodiment 6 to represent deviation of different image heights on the imaging surface after the light passes through the lens. According to FIG. 12A to FIG. 12D, it can be seen that the optical imaging system provided in embodiment 6 achieves high imaging quality.

### Embodiment 7

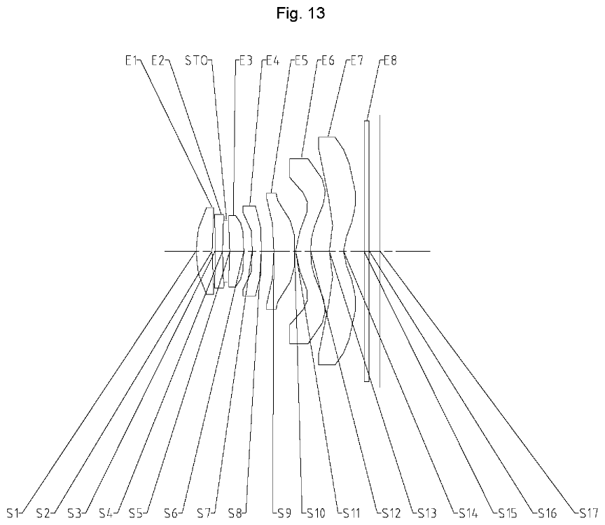

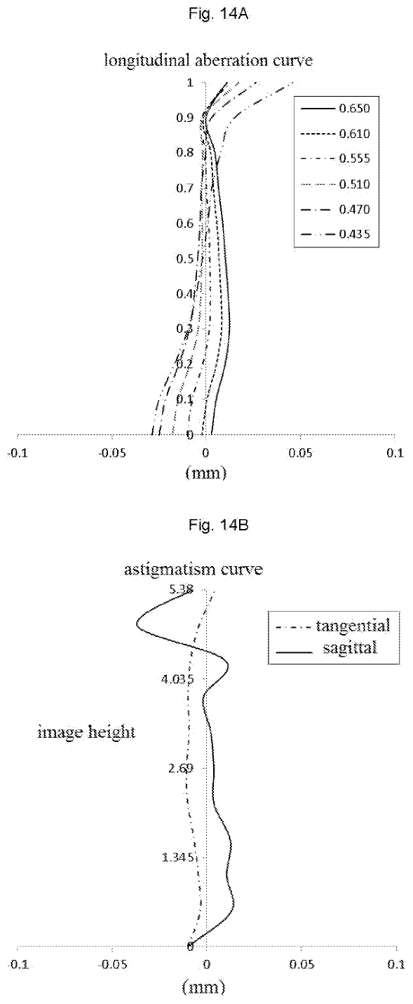

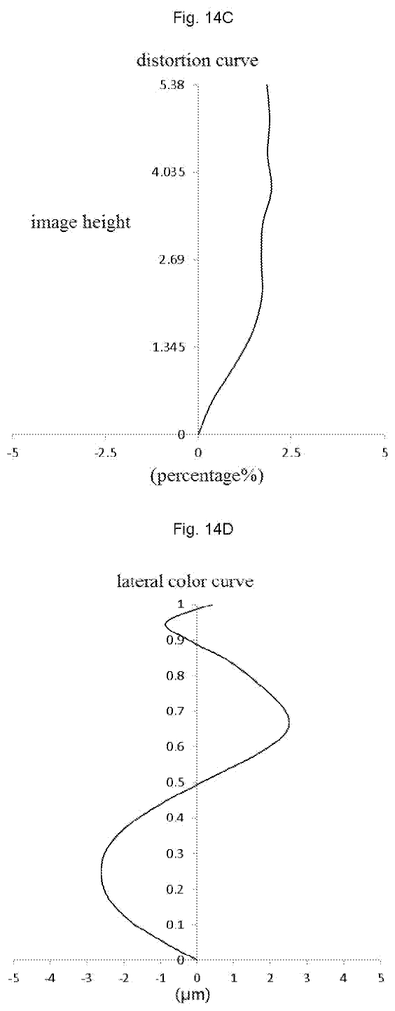

An optical imaging system according to embodiment 7 of the disclosure will be described below with reference to FIG. 13 to FIG. 14D. FIG. 13 illustrates a structure diagram of an optical imaging system according to embodiment 7 of the disclosure.

As shown in FIG. 13, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a negative refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a concave surface. The fifth lens E5 has a negative refractive power, an object-side surface S9 thereof is a concave surface, while an image-side surface S10 is a concave surface. The sixth lens E6 has a positive refractive power, an object-side surface S11 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.95 mm, a TTL of the optical imaging system is 7.31 mm, ImgH, a half of a diagonal length of an effective pixel region on the imaging surface S17 of the optical imaging system, is 5.38 mm, Semi-FOV, a half of a maximum field of view of the optical imaging system, is 46.8°, and Fno, an F-number of the optical imaging system, is 1.90.

Table 13 is a basic parameter table of the optical imaging system of embodiment 7, and units of the radius of curvature, the thickness/distance and the focal length are all mm. Tables 14-1 and 14-2 show high-order coefficients applied to each aspherical mirror surface in embodiment 7. A surface type of each aspherical surface is defined by formula (1) given in embodiment 1.

TABLE 13

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 4.0488 | 0.6468 | 1.55 | 56.1 | 10.36 | 0.0000 |
| S2 | Aspherical | 13.4582 | 0.1145 | | | | 0.0000 |
| S3 | Aspherical | 7.3189 | 0.3000 | 1.68 | 19.2 | −39.85 | 0.0000 |
| S4 | Aspherical | 5.6618 | 0.0839 | | | | 0.0000 |
| STO | Spherical | Infinite | 0.1960 | | | | |
| S5 | Aspherical | 12.1225 | 0.5658 | 1.55 | 56.1 | 10.74 | 0.0000 |
| S6 | Aspherical | −11.1637 | 0.3377 | | | | 0.0000 |
| S7 | Aspherical | −16.9722 | 0.3500 | 1.68 | 19.2 | −16.48 | 0.0000 |
| S8 | Aspherical | 32.8490 | 0.4967 | | | | 0.0000 |
| S9 | Aspherical | −11.4318 | 0.8284 | 1.55 | 56.1 | −8.35 | 0.0000 |
| S10 | Aspherical | 7.7700 | 0.0400 | | | | −0.2171 |
| S11 | Aspherical | 1.5390 | 0.5962 | 1.55 | 56.1 | 3.43 | −1.0000 |
| S12 | Aspherical | 7.4624 | 0.7424 | | | | 0.0000 |
| S13 | Aspherical | 2.0265 | 0.5621 | 1.54 | 55.7 | −6.90 | −1.0000 |
| S14 | Aspherical | 1.1830 | 0.8089 | | | | −1.0000 |
| S15 | Spherical | Infinite | 0.2100 | 1.62 | 64.2 | | |
| S16 | Spherical | Infinite | 0.4305 | | | | |
| S17 | Spherical | Infinite | | | | | |

TABLE 14-1

| Surface | | | | | | | |
|---|---|---|---|---|---|---|---|
| number | A4 | A6 | A8 | A10 | A12 | A14 | A16 |
| S1 | 1.1122E−03 | 4.0885E−03 | −7.1593E−03 | 1.0987E−02 | −1.0473E−02 | 6.2776E−03 | −2.2896E−03 |
| S2 | −2.6394E−02 | 3.1343E−02 | −1.7028E−02 | −5.2894E−03 | 1.9920E−02 | −1.8414E−02 | 8.6911E−03 |
| S3 | −7.8208E−02 | 4.4444E−02 | −2.6645E−02 | 1.1907E−02 | −2.2627E−03 | −1.4726E−03 | 1.7231E−03 |
| S4 | −7.1918E−02 | 1.4761E−02 | 2.6218E−02 | −8.1416E−02 | 1.2814E−01 | −1.2113E−01 | 7.0276E−02 |
| S5 | −2.7167E−02 | −1.5550E−02 | 2.8710E−02 | −8.0655E−02 | 1.3823E−01 | −1.4076E−01 | 8.4807E−02 |
| S6 | −2.8714E−02 | −2.8498E−02 | 4.1080E−02 | −7.4262E−02 | 8.9154E−02 | −6.7071E−02 | 3.0913E−02 |
| S7 | −5.8781E−02 | −1.4174E−02 | −3.4066E−03 | 2.1014E−02 | −2.9164E−02 | 2.7087E−02 | −1.4207E−02 |
| S8 | −3.5825E−02 | −1.1442E−02 | 1.5311E−02 | −1.6777E−02 | 1.4238E−02 | −6.9306E−03 | 1.8914E−03 |
| S9 | 2.2790E−03 | −1.0164E−02 | 2.8611E−02 | −4.7015E−02 | 4.5545E−02 | −2.9219E−02 | 1.2908E−02 |
| S10 | −2.8500E−01 | 1.9026E−01 | −3.3496E−02 | −1.1015E−01 | 1.6605E−01 | −1.3424E−01 | 7.2696E−02 |
| S11 | −1.4675E−01 | 1.4821E−01 | −1.3137E−01 | 8.1136E−02 | −3.7236E−02 | 1.3048E−02 | −3.5082E−03 |
| S12 | 1.7581E−01 | −1.2257E−01 | 4.8198E−02 | −1.3479E−02 | 2.8509E−03 | −4.7742E−04 | 6.6603E−05 |
| S13 | −1.5054E−01 | 2.3598E−02 | 1.5334E−02 | −1.3618E−02 | 5.6275E−03 | −1.4724E−03 | 2.6254E−04 |
| S14 | −2.1527E−01 | 9.2467E−02 | −3.3167E−02 | 9.3771E−03 | −2.0608E−03 | 3.4973E−04 | −4.5511E−05 |

TABLE 14-2

| Surface | | | | | | | |
|---|---|---|---|---|---|---|---|
| number | A18 | A20 | A22 | A24 | A26 | A28 | A30 |
| S1 | 4.6192E−04 | −3.9745E−05 | 0.0000E+00 | 0.0000E+00 | 0.0000E+00 | 0.0000E+00 | 0.0000E+00 |
| S2 | −2.1092E−03 | 2.0736E−04 | 0.0000E+00 | 0.0000E+00 | 0.0000E+00 | 0.0000E+00 | 0.0000E+00 |
| S3 | −6.8890E−04 | 9.9246E−05 | 0.0000E+00 | 0.0000E+00 | 0.0000E+00 | 0.0000E+00 | 0.0000E+00 |
| S4 | −2.2957E−02 | 3.2280E−03 | 0.0000E+00 | 0.0000E+00 | 0.0000E+00 | 0.0000E+00 | 0.0000E+00 |
| S5 | −2.7963E−02 | 3.8297E−03 | 0.0000E+00 | 0.0000E+00 | 0.0000E+00 | 0.0000E+00 | 0.0000E+00 |
| S6 | −8.0580E−03 | 8.9602E−04 | 0.0000E+00 | 0.0000E+00 | 0.0000E+00 | 0.0000E+00 | 0.0000E+00 |
| S7 | 3.7404E−03 | −3.8349E−04 | 0.0000E+00 | 0.0000E+00 | 0.0000E+00 | 0.0000E+00 | 0.0000E+00 |
| S8 | −2.7710E−04 | 1.7462E−05 | 0.0000E+00 | 0.0000E+00 | 0.0000E+00 | 0.0000E+00 | 0.0000E+00 |
| S9 | −3.9361E−03 | 8.1559E−04 | −1.1029E−04 | 8.8494E−06 | −3.2266E−07 | 0.0000E+00 | 0.0000E+00 |
| S10 | −2.7847E−02 | 7.6509E−03 | −1.4977E−03 | 2.0374E−04 | −1.8294E−05 | 9.7500E−07 | −2.3370E−08 |
| S11 | 7.1678E−04 | −1.0914E−04 | 1.2051E−05 | −9.2862E−07 | 4.6988E−08 | −1.3934E−09 | 1.8225E−11 |
| S12 | −8.0015E−06 | 8.0902E−07 | −6.4129E−08 | 3.6722E−09 | −1.3946E−10 | 3.1055E−12 | −3.0491E−14 |
| S13 | −3.2928E−05 | 2.9414E−06 | −1.8650E−07 | 8.2122E−09 | −2.3901E−10 | 4.1365E−12 | −3.2242E−14 |
| S14 | 4.4992E−06 | −3.3330E−07 | 1.8111E−08 | −6.9771E−10 | 1.7980E−11 | −2.7726E−13 | 1.9306E−15 |

FIG. 14A shows a longitudinal aberration curve of the optical imaging system according to embodiment 7 to represent deviation of a convergence focal point after light with different wavelengths passes through the lens. FIG. 14B shows an astigmatism curve of the optical imaging system according to embodiment 7 to represent a tangential image surface curvature and a sagittal image surface curvature. FIG. 14C shows a distortion curve of the optical imaging system according to embodiment 7 to represent distortion values corresponding to different image heights. FIG. 14D shows a lateral color curve of the optical imaging system according to embodiment 7 to represent deviation of different image heights on the imaging surface after the light passes through the lens. According to FIG. 14A to FIG. 14D, it can be seen that the optical imaging system provided in embodiment 7 achieves high imaging quality.

### Embodiment 8

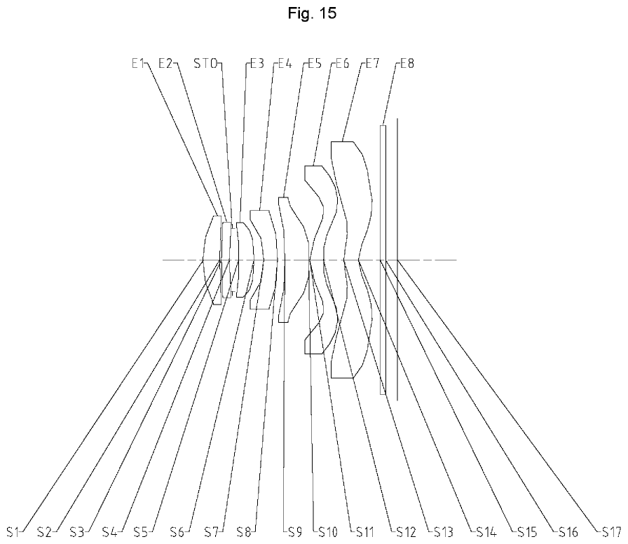

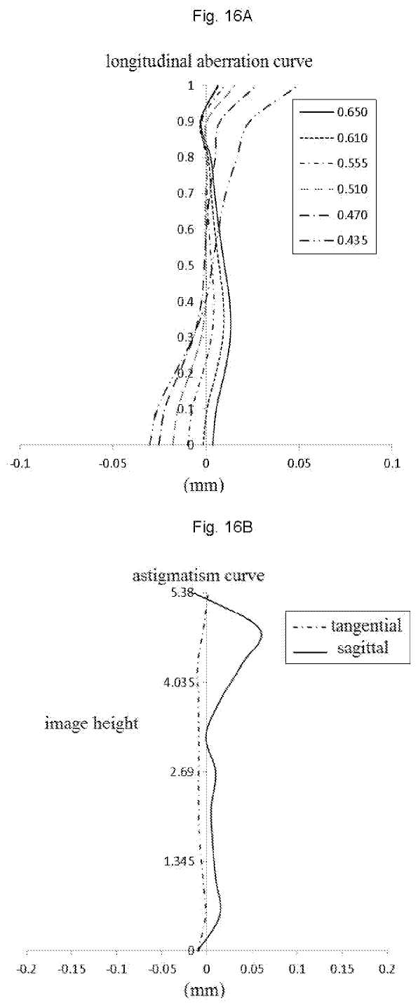

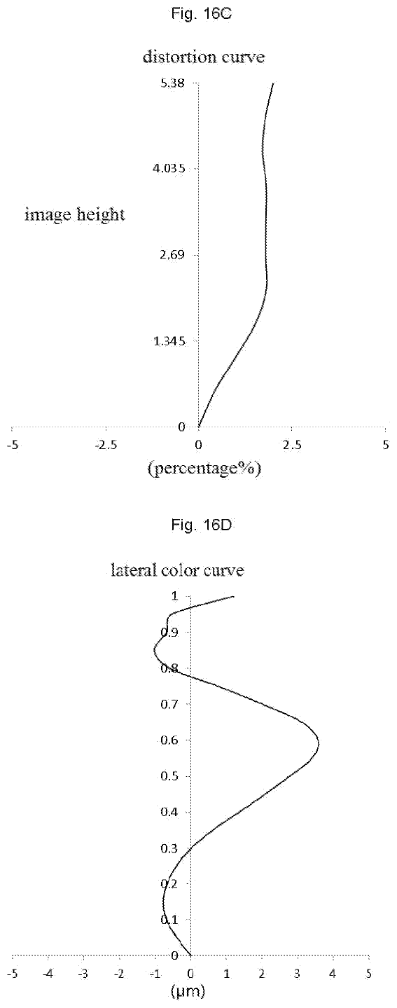

An optical imaging system according to embodiment 8 of the disclosure will be described below with reference to FIG. 15 to FIG. 16D. FIG. 15 illustrates a structure diagram of an optical imaging system according to embodiment 8 of the disclosure.

As shown in FIG. 15, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a positive refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a negative refractive power, an object-side surface S9 thereof is a concave surface, while an image-side surface S10 is a concave surface. The sixth lens E6 has a positive refractive power, an object-side surface 511 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.95 mm, a total track length TTL of the optical imaging system is 7.44 mm, ImgH, a half of a diagonal length of an effective pixel region on the imaging surface S17 of the optical imaging system, is 5.38 mm, Semi-FOV, a half of a maximum field of view of the optical imaging system, is 46.8°, and Fno, an F-number of the optical imaging system, is 1.90.

Table 15 is a basic parameter table of the optical imaging system of embodiment 8, and units of the radius of curvature, the thickness/distance and the focal length are all mm. Tables 16-1 and 16-2 show high-order coefficients applied to each aspherical mirror surface in embodiment 8. A surface type of each aspherical surface is defined by formula (1) given in embodiment 1.

TABLE 15

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 3.8433 | 0.6460 | 1.55 | 56.1 | 11.90 | 0.0000 |
| S2 | Aspherical | 8.8580 | 0.0719 | | | | 0.0000 |
| S3 | Aspherical | 4.9720 | 0.3000 | 1.68 | 19.2 | 166.67 | 0.0000 |
| S4 | Aspherical | 5.0745 | 0.1065 | | | | 0.0000 |
| STO | Spherical | Infinite | 0.2444 | | | | |
| S5 | Aspherical | 17.5661 | 0.5861 | 1.55 | 56.1 | 10.36 | 0.0000 |
| S6 | Aspherical | −8.2328 | 0.3751 | | | | 0.0000 |
| S7 | Aspherical | −4.3328 | 0.5204 | 1.68 | 19.2 | −9.16 | 0.0000 |
| S8 | Aspherical | −15.0617 | 0.2815 | | | | 0.0000 |
| S9 | Aspherical | −157.8289 | 0.9110 | 1.55 | 56.1 | −6.67 | 0.0000 |
| S10 | Aspherical | 3.7334 | 0.0400 | | | | −0.2727 |
| S11 | Aspherical | 1.4761 | 0.5297 | 1.55 | 56.1 | 2.77 | −1.0000 |
| S12 | Aspherical | 51.9779 | 0.7704 | | | | 0.0000 |
| S13 | Aspherical | 2.0439 | 0.5625 | 1.54 | 55.7 | −6.31 | −1.0000 |
| S14 | Aspherical | 1.1520 | 0.8279 | | | | −1.0000 |
| S15 | Spherical | Infinite | 0.2100 | 1.62 | 64.2 | | |
| S16 | Spherical | Infinite | 0.4541 | | | | |
| S17 | Spherical | Infinite | | | | | |

TABLE 16-1

| Surface | | | | | | | |
|---|---|---|---|---|---|---|---|
| number | A4 | A6 | A8 | A10 | A12 | A14 | A16 |
| S1 | 3.2874E−03 | 2.3468E−03 | −3.0035E−03 | 4.1909E−03 | −3.7617E−03 | 2.2032E−03 | −8.2485E−04 |
| S2 | −4.4776E−02 | 5.6501E−02 | −4.9881E−02 | 3.1211E−02 | −1.3223E−02 | 2.7149E−03 | 2.3731E−04 |
| S3 | −8.6623E−02 | 5.4437E−02 | −4.2319E−02 | 3.0780E−02 | −2.1737E−02 | 1.3582E−02 | −5.6691E−03 |
| S4 | −6.0870E−02 | 6.5637E−03 | 1.4591E−02 | −1.9631E−02 | 4.3038E−03 | 1.7256E−02 | −1.8785E−02 |
| S5 | −2.6496E−02 | −1.7974E−02 | 3.4439E−02 | −8.9888E−02 | 1.4064E−01 | −1.3201E−01 | 7.2882E−02 |
| S6 | −3.2105E−02 | −1.5522E−02 | −1.0810E−02 | 3.2821E−02 | −4.9038E−02 | 4.4671E−02 | −2.3900E−02 |
| S7 | −4.3847E−02 | 2.5676E−03 | −4.3515E−02 | 7.0892E−02 | −7.4011E−02 | 5.6876E−02 | −2.7487E−02 |
| S8 | −3.8519E−02 | 3.2460E−02 | −4.1523E−02 | 2.7817E−02 | −1.0653E−02 | 2.7906E−03 | −5.6110E−04 |
| S9 | −5.3113E−02 | 7.1180E−02 | −6.2087E−02 | 3.1169E−02 | −8.2999E−03 | −4.3407E−04 | 1.4311E−03 |
| S10 | −4.1737E−01 | 3.2471E−01 | −9.7628E−02 | −1.3535E−01 | 2.3510E−01 | −1.9285E−01 | 1.0244E−01 |
| S11 | −1.9450E−01 | 2.3787E−01 | −2.0718E−01 | 1.1364E−01 | −4.0218E−02 | 8.6508E−03 | −7.6575E−04 |
| S12 | 2.3907E−01 | −1.2717E−01 | 9.4677E−03 | 2.4889E−02 | −1.7202E−02 | 6.3089E−03 | −1.5214E−03 |
| S13 | −1.3274E−01 | 8.4234E−03 | 2.8218E−02 | −2.3813E−02 | 1.0933E−02 | −3.2656E−03 | 6.7013E−04 |
| S14 | −2.1201E−01 | 9.0358E−02 | −3.2680E−02 | 9.2969E−03 | −2.0429E−03 | 3.4534E−04 | −4.4710E−05 |

TABLE 16-2

| Surface | | | | | | | |
|---|---|---|---|---|---|---|---|
| number | A18 | A20 | A22 | A24 | A26 | A28 | A30 |
| S1 | 1.7660E−04 | −1.6924E−05 | 0.0000E+00 | 0.0000E+00 | 0.0000E+00 | 0.0000E+00 | 0.0000E+00 |
| S2 | −2.3020E−04 | 3.1309E−05 | 0.0000E+00 | 0.0000E+00 | 0.0000E+00 | 0.0000E+00 | 0.0000E+00 |
| S3 | 1.3191E−03 | −1.2840E−04 | 0.0000E+00 | 0.0000E+00 | 0.0000E+00 | 0.0000E+00 | 0.0000E+00 |
| S4 | 7.8980E−03 | −1.2257E−03 | 0.0000E+00 | 0.0000E+00 | 0.0000E+00 | 0.0000E+00 | 0.0000E+00 |
| S5 | −2.1693E−02 | 2.5901E−03 | 0.0000E+00 | 0.0000E+00 | 0.0000E+00 | 0.0000E+00 | 0.0000E+00 |
| S6 | 6.8357E−03 | −8.2495E−04 | 0.0000E+00 | 0.0000E+00 | 0.0000E+00 | 0.0000E+00 | 0.0000E+00 |
| S7 | 7.1507E−03 | −7.5591E−04 | 0.0000E+00 | 0.0000E+00 | 0.0000E+00 | 0.0000E+00 | 0.0000E+00 |
| S8 | 7.7742E−05 | −4.9597E−06 | 0.0000E+00 | 0.0000E+00 | 0.0000E+00 | 0.0000E+00 | 0.0000E+00 |
| S9 | −6.2721E−04 | 1.4681E−04 | −2.0070E−05 | 1.5090E−06 | −4.8303E−08 | 0.0000E+00 | 0.0000E+00 |
| S10 | −3.7833E−02 | 9.9193E−03 | −1.8414E−03 | 2.3665E−04 | −2.0025E−05 | 1.0037E−06 | −2.2577E−08 |
| S11 | −1.4196E−04 | 6.1208E−05 | −1.0503E−05 | 1.0642E−06 | −6.6021E−08 | 2.3293E−09 | −3.5942E−11 |
| S12 | 2.5585E−04 | −3.0544E−05 | 2.5797E−06 | −1.5070E−07 | 5.7918E−09 | −1.3173E−10 | 1.3433E−12 |
| S13 | −9.6831E−05 | 9.9366E−06 | −7.2015E−07 | 3.6038E−08 | −1.1850E−09 | 2.3041E−11 | −2.0079E−13 |
| S14 | 4.3979E−06 | −3.2431E−07 | 1.7548E−08 | −6.7328E−10 | 1.7282E−11 | −2.6545E−13 | 1.8411E−15 |

FIG. 16A shows a longitudinal aberration curve of the optical imaging system according to embodiment 8 to represent deviation of a convergence focal point after light with different wavelengths passes through the lens. FIG. 16B shows an astigmatism curve of the optical imaging system according to embodiment 8 to represent a tangential image surface curvature and a sagittal image surface curvature. FIG. 16C shows a distortion curve of the optical imaging system according to embodiment 8 to represent distortion values corresponding to different image heights. FIG. 16D shows a lateral color curve of the optical imaging system according to embodiment 8 to represent deviation of different image heights on the imaging surface after the light passes through the lens. According to FIG. 16A to FIG. 16D, it can be seen that the optical imaging system provided in embodiment 8 achieves high imaging quality.

### Embodiment 9

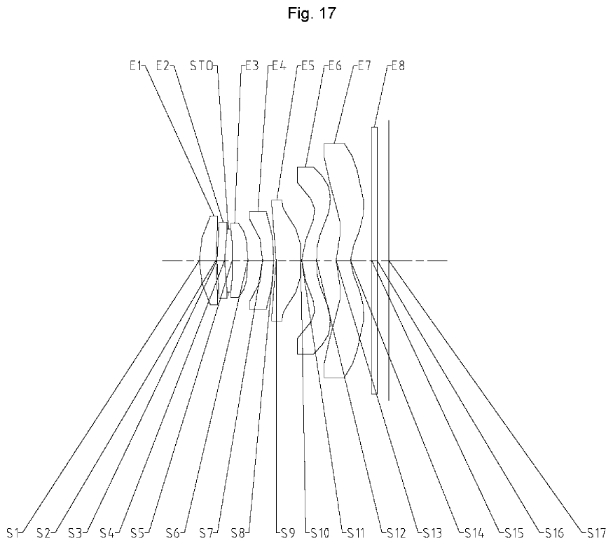

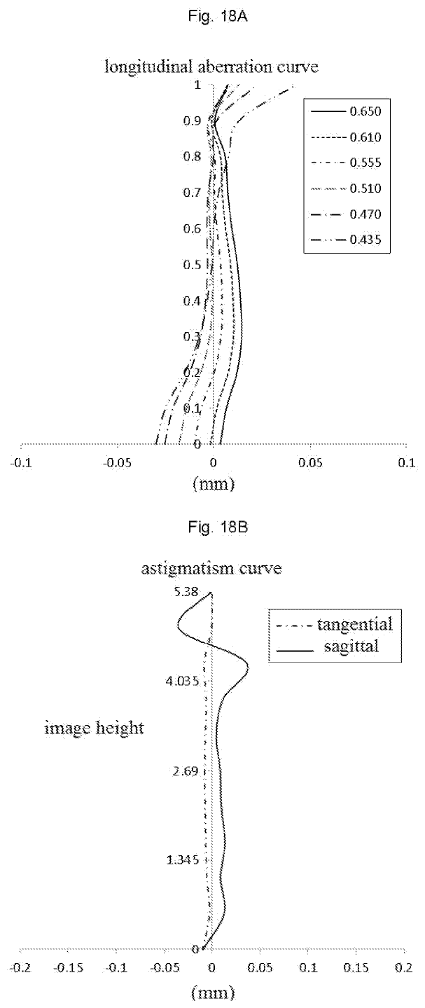

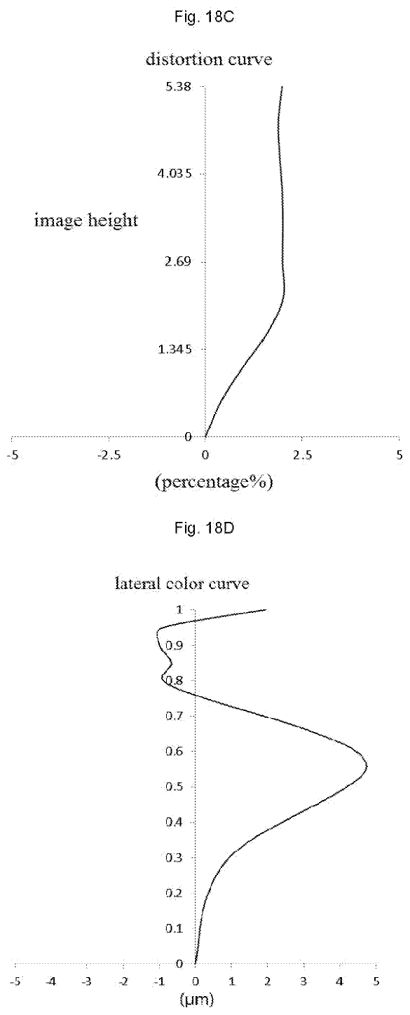

An optical imaging system according to embodiment 9 of the disclosure will be described below with reference to FIG. 17 to FIG. 18D. FIG. 17 illustrates a structure diagram of an optical imaging system according to embodiment 9 of the disclosure.

As shown in FIG. 17, the optical imaging system sequentially includes, from an object side to an image side, a first lens E1, a second lens E2, a diaphragm STO, a third lens E3, a fourth lens E4, a fifth lens E5, a sixth lens E6, a seventh lens E7, an optical filter E8, and an imaging surface S17.

The first lens E1 has a positive refractive power, an object-side surface S1 thereof is a convex surface, while an image-side surface S2 is a concave surface. The second lens E2 has a positive refractive power, an object-side surface S3 thereof is a convex surface, while an image-side surface S4 is a concave surface. The third lens E3 has a positive refractive power, an object-side surface S5 thereof is a convex surface, while an image-side surface S6 is a convex surface. The fourth lens E4 has a negative refractive power, an object-side surface S7 thereof is a concave surface, while an image-side surface S8 is a convex surface. The fifth lens E5 has a negative refractive power, an object-side surface S9 thereof is a concave surface, while an image-side surface 510 is a concave surface. The sixth lens E6 has a positive refractive power, an object-side surface 511 thereof is a convex surface, while an image-side surface S12 is a concave surface. The seventh lens E7 has a negative refractive power, an object-side surface S13 thereof is a convex surface, while an image-side surface S14 is a concave surface. The optical filter E8 has an object-side surface S15 and an image-side surface S16. Light from an object sequentially passes through each of the surfaces S1 to S16 and is finally imaged on the imaging surface S17.

In the example, a total effective focal length f of the optical imaging system is 4.95 mm, a total track length TTL of the optical imaging system is 7.41 mm, ImgH, a half of a diagonal length of an effective pixel region on the imaging surface S17 of the optical imaging system, is 5.38 mm, Semi-FOV, a half of a maximum field of view of the optical imaging system, is 46.8°, and Fno, an F-number of the optical imaging system, is 1.90.

Table 17 is a basic parameter table of the optical imaging system of embodiment 9, and units of the radius of curvature, the thickness/distance and the focal length are all mm. Tables 18-1 and 18-2 show high-order coefficients applied to each aspherical mirror surface in embodiment 9. A surface type of each aspherical surface is defined by formula (1) given in embodiment 1.

TABLE 17

| | | | | Material | | | |
|---|---|---|---|---|---|---|---|
| Surface | Surface | Radius of | Thickness/ | Refractive | Abbe | Focal | Conic |
| number | type | curvature | distance | index | number | length | coefficient |
| OBJ | Spherical | Infinite | Infinite | | | | |
| S1 | Aspherical | 4.0499 | 0.6410 | 1.55 | 56.1 | 13.57 | 0.0000 |
| S2 | Aspherical | 8.4396 | 0.0438 | | | | 0.0000 |
| S3 | Aspherical | 4.1136 | 0.3000 | 1.68 | 19.2 | 200.00 | 0.0000 |
| S4 | Aspherical | 4.1177 | 0.1425 | | | | 0.0000 |
| STO | Spherical | Infinite | 0.1531 | | | | |
| S5 | Aspherical | 16.2755 | 0.6137 | 1.55 | 56.1 | 9.61 | 0.0000 |
| S6 | Aspherical | −7.6318 | 0.5787 | | | | 0.0000 |
| S7 | Aspherical | −4.0849 | 0.4403 | 1.68 | 19.2 | −8.48 | 0.0000 |
| S8 | Aspherical | −14.7963 | 0.0912 | | | | 0.0000 |
| S9 | Aspherical | −63.6600 | 0.9597 | 1.55 | 56.1 | −10.18 | 0.0000 |
| S10 | Aspherical | 6.1175 | 0.0400 | | | | −0.6454 |
| S11 | Aspherical | 1.6043 | 0.5764 | 1.55 | 56.1 | 3.27 | −1.0000 |
| S12 | Aspherical | 13.7741 | 0.7743 | | | | 0.0000 |
| S13 | Aspherical | 1.8963 | 0.5625 | 1.54 | 55.7 | −7.47 | −1.0000 |
| S14 | Aspherical | 1.1538 | 0.8275 | | | | −1.0000 |
| S15 | Spherical | Infinite | 0.2100 | 1.62 | 64.2 | | |
| S16 | Spherical | Infinite | 0.4550 | | | | |
| S17 | Spherical | Infinite | | | | | |

TABLE 18-1

| Surface | | | | | | | |
|---|---|---|---|---|---|---|---|
| number | A4 | A6 | A8 | A10 | A12 | A14 | A16 |
| S1 | 4.3393E−03 | 4.6647E−03 | −8.7448E−03 | 1.1927E−02 | −1.0187E−02 | 5.6571E−03 | −1.9772E−03 |
| S2 | −6.4167E−02 | 1.1163E−01 | −1.4033E−01 | 1.2925E−01 | −8.3034E−02 | 3.5320E−02 | −9.5165E−03 |
| S3 | −1.0582E−01 | 1.0103E−01 | −1.2756E−01 | 1.3043E−01 | −9.5576E−02 | 4.7800E−02 | −1.5138E−02 |
| S4 | −6.1016E−02 | −3.1175E−03 | 5.5820E−02 | −1.5635E−01 | 2.6447E−01 | −2.7060E−01 | 1.6708E−01 |
| S5 | −2.6818E−02 | −1.9274E−02 | 2.1823E−02 | −3.5171E−02 | 2.6575E−02 | 1.3160E−03 | −1.4538E−02 |
| S6 | −2.9064E−02 | −2.7808E−02 | 6.1573E−02 | −1.4032E−01 | 1.9572E−01 | −1.6668E−01 | 8.5119E−02 |
| S7 | −4.2829E−02 | 7.6043E−03 | −2.5419E−02 | 1.2410E−02 | 8.0032E−03 | −6.1021E−03 | 8.4804E−05 |
| S8 | −9.8725E−02 | 1.6397E−01 | −1.8089E−01 | 1.0159E−01 | −2.6238E−02 | 8.9372E−04 | 1.0844E−03 |
| S9 | −1.2222E−01 | 2.1384E−01 | −1.9276E−01 | 7.4787E−02 | 9.4173E−03 | −2.5718E−02 | 1.4553E−02 |
| S10 | −3.5394E−01 | 2.7735E−01 | −7.6373E−02 | −1.4087E−01 | 2.4083E−01 | −2.0253E−01 | 1.1084E−01 |
| S11 | −1.6238E−01 | 1.8538E−01 | −1.6030E−01 | 9.0080E−02 | −3.3629E−02 | 7.9847E−03 | −9.7697E−04 |
| S12 | 2.0781E−01 | −1.4354E−01 | 5.4231E−02 | −1.1086E−02 | −1.7600E−04 | 8.8279E−04 | −2.9569E−04 |
| S13 | −1.3227E−01 | 1.0531E−02 | 2.1913E−02 | −1.8539E−02 | 8.4676E−03 | −2.5144E−03 | 5.1100E−04 |
| S14 | −2.0290E−01 | 8.1236E−02 | −2.7471E−02 | 7.2448E−03 | −1.4670E−03 | 2.2831E−04 | −2.7310E−05 |

TABLE 18-2

| Surface | | | | | | | |
|---|---|---|---|---|---|---|---|
| number | A18 | A20 | A22 | A24 | A26 | A28 | A30 |
| S1 | 3.9406E−04 | −3.4715E−05 | 0.0000E+00 | 0.0000E+00 | 0.0000E+00 | 0.0000E+00 | 0.0000E+00 |
| S2 | 1.4944E−03 | −1.0803E−04 | 0.0000E+00 | 0.0000E+00 | 0.0000E+00 | 0.0000E+00 | 0.0000E+00 |
| S3 | 2.7297E−03 | −2.1213E−04 | 0.0000E+00 | 0.0000E+00 | 0.0000E+00 | 0.0000E+00 | 0.0000E+00 |
| S4 | −5.7217E−02 | 8.3852E−03 | 0.0000E+00 | 0.0000E+00 | 0.0000E+00 | 0.0000E+00 | 0.0000E+00 |
| S5 | 8.2818E−03 | −1.5205E−03 | 0.0000E+00 | 0.0000E+00 | 0.0000E+00 | 0.0000E+00 | 0.0000E+00 |
| S6 | −2.4010E−02 | 2.8672E−03 | 0.0000E+00 | 0.0000E+00 | 0.0000E+00 | 0.0000E+00 | 0.0000E+00 |
| S7 | 6.5871E−04 | −1.1813E−04 | 0.0000E+00 | 0.0000E+00 | 0.0000E+00 | 0.0000E+00 | 0.0000E+00 |
| S8 | −2.3451E−04 | 1.5692E−05 | 0.0000E+00 | 0.0000E+00 | 0.0000E+00 | 0.0000E+00 | 0.0000E+00 |
| S9 | −4.8231E−03 | 1.0443E−03 | −1.4621E−04 | 1.2064E−05 | −4.4604E−07 | 0.0000E+00 | 0.0000E+00 |
| S10 | −4.2126E−02 | 1.1331E−02 | −2.1502E−03 | 2.8135E−04 | −2.4143E−05 | 1.2223E−06 | −2.7664E−08 |
| S11 | −3.7478E−05 | 3.8582E−05 | −7.4688E−06 | 7.9811E−07 | −5.1104E−08 | 1.8427E−09 | −2.8907E−11 |
| S12 | 5.5475E−05 | −6.7515E−06 | 5.4960E−07 | −2.9573E−08 | 1.0016E−09 | −1.9091E−11 | 1.5264E−13 |
| S13 | −7.2708E−05 | 7.3021E−06 | −5.1498E−07 | 2.4954E−08 | −7.9122E−10 | 1.4788E−11 | −1.2355E−13 |
| S14 | 2.4967E−06 | −1.7214E−07 | 8.7527E−09 | −3.1685E−10 | 7.6997E−12 | −1.1232E−13 | 7.4217E−16 |

FIG. 18A shows a longitudinal aberration curve of the optical imaging system according to embodiment 9 to represent deviation of a convergence focal point after light with different wavelengths passes through the lens. FIG. 18B shows an astigmatism curve of the optical imaging system according to embodiment 9 to represent a tangential image surface curvature and a sagittal image surface curvature. FIG. 18C shows a distortion curve of the optical imaging system according to embodiment 9 to represent distortion values corresponding to different image heights. FIG. 18D shows a lateral color curve of the optical imaging system according to embodiment 9 to represent deviation of different image heights on the imaging surface after the light passes through the lens. According to FIG. 18A to FIG. 18D, it can be seen that the optical imaging system provided in embodiment 9 achieves high imaging quality.

From the above, embodiment 1 to embodiment 9 meet a relationship shown in Table 19 respectively.

TABLE 19

| Conditional | embodiment | | | | | | | | |
|---|---|---|---|---|---|---|---|---|---|
| expression | 1 | 2 | 3 | 4 | 5 | 6 | 7 | 8 | 9 |
| TTL/ImgH | 1.34 | 1.34 | 1.34 | 1.34 | 1.35 | 1.35 | 1.36 | 1.38 | 1.38 |
| T67/CT6 | 1.20 | 1.47 | 1.51 | 1.57 | 1.58 | 1.45 | 1.25 | 1.45 | 1.34 |
| f1/f | 1.95 | 1.83 | 1.84 | 1.88 | 1.87 | 1.91 | 2.09 | 2.40 | 2.74 |
| f3/f4 | −0.71 | −0.72 | −0.72 | −0.75 | −0.73 | −0.72 | −0.65 | −1.13 | −1.13 |
| f7/f | −1.50 | −1.44 | −1.44 | −1.42 | −1.39 | −1.39 | −1.39 | −1.27 | −1.51 |
| R3/R1 | 1.16 | 1.56 | 1.57 | 1.50 | 1.51 | 1.97 | 1.81 | 1.29 | 1.02 |
| R2/R4 | 4.06 | 3.59 | 3.58 | 3.45 | 3.73 | 2.68 | 2.38 | 1.75 | 2.05 |
| R5/R6 | −1.73 | −5.80 | −5.31 | −5.42 | −3.11 | −1.92 | −1.09 | −2.13 | −2.13 |
| R13/R14 | 1.73 | 1.70 | 1.70 | 1.70 | 1.73 | 1.72 | 1.71 | 1.77 | 1.64 |
| CT3/CT2 | 1.78 | 1.79 | 1.80 | 1.79 | 1.82 | 1.79 | 1.89 | 1.95 | 2.05 |
| CT1/T23 | 2.06 | 1.99 | 1.99 | 1.97 | 1.92 | 2.30 | 2.31 | 1.84 | 2.17 |
| CT5/CT4 | 2.12 | 2.45 | 2.45 | 2.42 | 2.41 | 2.37 | 2.37 | 1.75 | 2.18 |

Some embodiments of the disclosure also provide an imaging device, of which an electronic photosensitive element may be a CCD or a CMOS. The imaging device may be an independent imaging device such as a digital camera, or may be an imaging module integrated into a mobile electronic device such as a mobile phone. The imaging device is provided with the above mentioned optical imaging system.

The above description is only description about the some embodiments of the disclosure and adopted technical principles. It is understood by those skilled in the art that the scope of disclosure involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An optical imaging system, sequentially comprising, from an object side to an image side along an optical axis: a first lens, a second lens, a third lens, a fourth lens, a fifth lens, a sixth lens and a seventh lens with refractive powers; and
a diaphragm arranged between the second lens and the third lens,
wherein an effective focal length f1 of the first lens and a total effective focal length f of the optical imaging system meet 1.5<f1/f<3.0; and
a radius of curvature R13 of an object-side surface of the seventh lens and a radius of curvature R14 of an image-side surface of the seventh lens meet 1.5<R13/R14<2.0.

2. The optical imaging system according to claim 1, wherein Fno, an F-number of the optical imaging system, meets Fno<2.0.

3. The optical imaging system according to claim 1, wherein an effective focal length f3 of the third lens and an effective focal length f4 of the fourth lens meet −1.5<f3/f4<−0.5.

4. The optical imaging system according to claim 1, wherein an effective focal length f7 of the seventh lens and the total effective focal length f of the optical imaging system meet −2.0<f7/f<−1.0.

5. The optical imaging system according to claim 1, wherein a radius of curvature R3 of an object-side surface of the second lens and a radius of curvature R1 of an object-side surface of the first lens meet 1.0<R3/R1<2.0.

6. The optical imaging system according to claim 1, wherein a radius of curvature R2 of an image-side surface of the first lens and a radius of curvature R4 of an image-side surface of the second lens meet 1.5<R2/R4<4.5.

7. The optical imaging system according to claim 1, wherein a radius of curvature R5 of an object-side surface of the third lens and a radius of curvature R6 of an image-side surface of the third lens meet −6.0<R5/R6<−1.0.

8. The optical imaging system according to claim 1, wherein a center thickness CT3 of the third lens on the optical axis and a center thickness CT2 of the second lens on the optical axis meet 1.5<CT3/CT2<2.5.

9. The optical imaging system according to claim 1, wherein a center thickness CT1 of the first lens on the optical axis and a spacing distance T23 of the second lens and the third lens on the optical axis meet 1.5<CT1/T23<2.5.

10. The optical imaging system according to claim 1, wherein a center thickness CT5 of the fifth lens on the optical axis and a center thickness CT4 of the fourth lens on the optical axis meet 1.5<CT5/CT4<2.5.

11. The optical imaging system according to claim 1, wherein a spacing distance T67 of the sixth lens and the seventh lens on the optical axis and a center thickness CT6 of the sixth lens on the optical axis meet T67/CT6>1.0

12. The optical imaging system according to claim 1, wherein semi-field of view (Semi-FOV), a half of a maximum field of view of the optical imaging system, meets Semi-FOV≥45°.

13. The optical imaging system according to claim 1, wherein TTL, a distance from an object-side surface of the first lens to an imaging surface of the optical imaging system on the optical axis and ImgH, a half of a diagonal length of an effective pixel region on the imaging surface of the optical imaging system meet TTL/ImgH<1.5.

14. An optical imaging system, sequentially comprising, from an object side to an image side along an optical axis: a first lens, a second lens, a third lens, a fourth lens, a fifth lens, a sixth lens and a seventh lens with refractive powers; and
a diaphragm arranged between the second lens and the third lens,
wherein an effective focal length f1 of the first lens and a total effective focal length f of the optical imaging system meet 1.5<f1/f<3.0; and
a center thickness CT1 of the first lens on the optical axis and a spacing distance T23 of the second lens and the third lens on the optical axis meet 1.5<CT1/T23<2.5.

15. The optical imaging system according to claim 14, wherein a radius of curvature R3 of an object-side surface of the second lens and a radius of curvature R1 of an object-side surface of the first lens meet 1.0<R3/R1<2.0.

16. The optical imaging system according to claim 14, wherein a radius of curvature R2 of an image-side surface of the first lens and a radius of curvature R4 of an image-side surface of the second lens meet 1.5<R2/R4<4.5.

17. The optical imaging system according to claim 14, wherein a radius of curvature R5 of an object-side surface of the third lens and a radius of curvature R6 of an image-side surface of the third lens meet −6.0<R5/R6<−1.0.

18. The optical imaging system according to claim 14, wherein a center thickness CT3 of the third lens on the optical axis and a center thickness CT2 of the second lens on the optical axis meet 1.5<CT3/CT2<2.5.

19. The optical imaging system according to claim 14, wherein a center thickness CT5 of the fifth lens on the optical axis and a center thickness CT4 of the fourth lens on the optical axis meet 1.5<CT5/CT4<2.5.

20. The optical imaging system according to claim 14, wherein an effective focal length f3 of the third lens and an effective focal length f4 of the fourth lens meet −1.5<f3/f4<−0.5.
